(19) United States
(12) Patent Application Publication
(10) Pub. No.: US 2025/0383630 A1
(43) Pub. Date: Dec. 18, 2025

(54) BISTABLE TIMEPIECE CONTROL MECHANISM

(71) Applicant: LVMH SWISS MANUFACTURES SA, La Chaux-de-Fonds (CH)

(72) Inventors: Pavel SAVINTCEV, Neuchâtel (CH); Thibaud FAIVRE CHALON, Neuchâtel (CH); Sébastien RUFFIEUX, Le Locle (CH)

(21) Appl. No.: 18/877,319

(22) PCT Filed: Jun. 22, 2023
(86) PCT No.: PCT/IB2023/056465

§ 371 Date: Dec. 20, 2024

(30) Foreign Application Priority Data
Jun. 23, 2022 (CH) 00757/2022
Jun. 23, 2022 (FR) FR2206272

(51) Int. Cl. G04F 7/08

(52) U.S. Cl. CPC G04F 7/0866; G04F 7/0804; G04F 7/0842

(57) ABSTRACT

The present disclosure concerns a watch mechanism having, in a main plane: an actuating device, a pivoting piece arranged to pivot under the action of the actuating device around an axis perpendicular to the main plane, a rigid piece, a first flexible blade connecting the rigid piece to the pivoting piece, a mechanical pivot having a main axis offset in the main plane from the axis of rotation of at least one of the pivoting piece and the rigid piece, the pivoting piece being mounted on said mechanical pivot, which preloads the first flexible blade and makes the assembly formed by the rigid piece and the first flexible blade bistable, so that the rotating pivoting piece causes the bistable assembly to move in the main plane, from a first stable position, to a second stable position.

### TECHNICAL AREA

The present invention relates to a watch mechanism for a chronograph watch. The present invention also relates to a watch movement comprising such a mechanism, as well as to a timepiece, for example a chronograph watch, in particular a wrist chronograph watch, comprising such a mechanism or movement. Although the mechanism according to the invention can be used in a chronograph watch, it is not limited to such an application, but can also be used for any other watchmaking application which requires the control or actuation of a function, for example and in a non-limiting way, it can be used in a flyback hand watch mechanism, a minute repeater watch mechanism, a countdown watch mechanism, for example for a regatta watch, etc.

### STATE OF THE ART

A chronograph watch is a timepiece allowing to perform a measuring of a duration. As a general rule, a chronograph watch comprises at least one indicator (such as a hand) which can be switched on and off, by means of a push-button or other control member, in order to measure a duration. It can then be returned to its starting point. Chronograph watches generally comprise indicators for displaying the current time in addition to the measured duration.

When a push-button (or other actuating device) on a chronograph watch is first pressed, the trotteuse indicator or hand (also known as the “chronograph seconds indicator” or “chronograph seconds hand”), which is at rest on the zero division of the dial, starts (start phase or “start”). A second press on the same or another push-button stops the trotteuse at the precise point it was at when pressed (stop phase or “stop”). A third press on the same or another push-button quickly returns the trotteuse to its starting point, i.e. the zero division of the dial (reset phase or “reset”). In this way, it is possible to measure in seconds a duration.

The three phases or functions of a chronograph watch are start, stop and reset.

In some chronograph watches, the energy source required to set in motion the kinematic chain used to measure a time duration is independent from that of the kinematic chain used to count and display the current time. However, in most cases, chronograph watches draw the energy required to operate the time-measuring part of the movement from the kinematic chain used to count and display the current time, i.e. from the kinematic chain linking an energy source, such as a barrel, to the regulating organ and the watch wheels, which are linked to the watch indicators to display the current hour, minutes and/or seconds.

In these cases, it is necessary to create a coupling between the kinematic chain for counting and displaying the current time and the one for measuring a time duration, to extract the energy required to set in motion the kinematic chain for measuring a time duration.

Two main components are used in the majority of chronograph watch mechanisms: coupling mechanisms and control mechanisms.

Coupling mechanisms enable the chronograph drive train to be driven by the drive train used to count and display the current time. Notably, coupling mechanisms enable the chronograph kinematic chain to be started and stopped very quickly, and also to be blocked by keeping the chronograph indicator(s) stopped.

Various types of coupling mechanism, including vertical, horizontal and oscillating pinion couplings, are known in the art and will not be described here.

Known control mechanisms can be cam or column-wheel type, for example.

The column wheel is generally made in one piece and comprises a ratchet and columns perpendicular to the ratchet. The columns create known full and empty spaces to control the various movements of the levers, which rest against a column or are located between two columns. The levers and their movements, which enable the “start”, “stop” and “reset” functions to be carried out, are known per se in the field of technology and will therefore not be described here.

The cam-operated mechanism generally comprises two at least partially superimposed parts (also known as shuttles), which are integral with each other. The cam actuates levers to perform functions like those of a column wheel.

Documents CH716594 and CH716595 propose an alternative to known column wheels, which are relatively thick and difficult to manufacture. The proposed solution is a mechanism comprising a single-layer part capable of rotation (always referred to as a “column wheel” in these documents), elastically linked to a frame and provided with two stable positions relative to the frame, this part being movable between these two stable positions by actuating a lever. The lever is connected to the frame by at least one flexible blade, which ensures that the lever has a preferred position to which it automatically returns after leaving it. This mechanism has no mechanical (rigid) pivots, and comprises only flexible pivots. It includes bistables, even when not mounted in a watch movement. It is thinner than known mechanisms. This mechanism cannot be reset to zero.

The document EP3582029 describes a flyback hand mechanism comprising a monobloc flyback hand clamp. This clamp comprises two arms and a deformable by flexure elastic transverse arm, which connects the two arms to each other. This arm comprises at its ends two pivoting members designed to rotate around two parallel axes. As a result, the two arms can move towards and away from each other, thanks to the elastic cross arm. The elastic cross arm is subject to stresses that render its undeformed configuration unstable. In order to regain a stable configuration in which stresses are reduced, the elastic cross arm adopts a buckled or curved shape. A moving part is arranged to cooperate with the resilient transverse arm, so that, when a control device is switched, passage of the moving part from one to the other of its two configurations causes the curvature of the elastic transverse arm to change, thus alternately opening and closing the rattrapante clamp. The two arms of the flyback hand clamp are arranged to cooperate with a flyback hand wheel, so that the flyback hand wheel is immobilized or free to rotate depending on whether the flyback hand clamp is closed or open respectively.

The mechanism of document EP3582029 has certain disadvantages: the cross arm is guided by two pins. The action of these pins at the same place of the cross arm, which is relatively thin, risks to damage or even break the cross arm. What's more, the rotation of the (rigid) pivoting members is caused by the bending of the arm: this causal link makes the mechanism's operation less efficient.

The document EP3327518 describes a chronograph mechanism capable of switching between a first state and a second state, comprising, among other things, a first bipolar magnet, a second bipolar magnet interacting magnetically with the first bipolar magnet, and a highly magnetically permeable element forming a control member. The operation of this mechanism is not entirely mechanical, as it also relies on magnetic interaction between these components.

The document US2019332061 describes a flexible monolithic component for transmitting motion from an actuating device to a driven part. The monolithic component comprises a first rigid drive member attached to the rigid frame by an elastically flexible structure, and a possible second rigid functional member attached to the rigid frame by a second elastically flexible structure. An actuating finger slides over a portion of a first rigid drive member, generating a displacement of the latter controlled by the blades. One end of the hook-shaped rigid drive member constitutes a drive means able to engage with the teeth of the driven part. The drive means performs a movement with a component parallel and a component perpendicular to the circumference of the driven part. In this way, the entire first drive member performs an alternating two-dimensional oscillating movement, thanks to the elastic deformation of the blades.

The document EP3876042 describes a chronograph reset system comprising a minute counter having a minute wheel and a seconds counter with a chrono wheel. A hammer is held locked by a locking means and is movable between an inactive position and an active position. A flexible element connected between a reset control means and the hammer is used for chronograph resetting, and it is configured so as to store energy upon displacement of the control means prior to hammer release by the blocking means, to be able to restore this stored energy to measurement, upon hammer release, and drive the hammer for chronograph resetting.

### BRIEF SUMMARY OF THE INVENTION

One aim of the present invention is to provide a watch mechanism free from the limitations of known mechanisms.

Another aim of the invention is to propose a watch mechanism alternative to known mechanisms.

Another aim of the invention is to propose a watch mechanism with a reduced number of parts compared to known solutions.

Another aim of the invention is to propose a watch mechanism that has a reduced number of wear parts compared with known solutions.

Another aim of the invention is to provide a watch mechanism that can also be used for a reset.

Another aim of the invention is to offer a watch mechanism with a lower risk of breakage than known solutions.

Another aim of the invention is to propose a watch mechanism in which the causal link that enables a function to be executed, is different from that of known solutions.

A further aim of the invention is to propose a watch mechanism in which this causal link enables the operation of the watch mechanism to be improved over known solutions.

According to the invention, these aims are achieved in particular by means of the watch mechanism according to claim 1, preferential embodiments being given in the dependent claims.

According to an independent aspect, the invention relates to a mechanism comprising in a main plane:
an actuating device,
a pivoting piece, arranged to pivot under the action of the actuating device around an axis perpendicular to the main plane,
a rigid piece,
a first flexible blade connecting the rigid piece to the pivoting piece,
a mechanical pivot having a main axis offset in the main plane from the axis of rotation by at least one between the pivoting piece and the rigid piece, the pivoting piece respectively the rigid piece being mounted on said mechanical pivot, which preloads the first flexible blade and makes the assembly formed by the rigid piece and the first flexible blade bistable, so that the pivoting piece rotating causes the bistable assembly to move in the main plane, from a first stable position to a second stable position.

In the watch mechanism described here, the flexible blade is not guided, which reduces or eliminates the risk of breakage.

In the watch mechanism according to the invention, the rotation of the pivoting piece causes, via the flexible blade, the displacement of the bistable assembly. In other words, in the watch mechanism according to the invention, the input that enables a function to be performed is not the bending of a flexible blade, but the rotation of a pivoting (rigid) piece. This causal link is different from that proposed in the prior art and enables improved operation of the watch mechanism according to the invention.

In one embodiment, the watch mechanism also comprises:
a frame, the rigid piece being disposed between the frame and the pivoting piece,
a second flexible blade connecting the rigid piece to the frame, and being preloaded by the pivoting piece mounted on the mechanical pivot, the bistable assembly also comprising the second flexible blade,
the bistable assembly moves from a first stable position relative to the frame, to a second stable position relative to the frame.

In one embodiment, the pivoting piece is arranged to rotate also from a first stable position to a second stable position;
when the pivoting piece is in its first stable position, the bistable assembly is also in its first stable position and when the pivoting piece is in its second stable position, the bistable assembly is also in its second stable position.

In one embodiment, a stable position is a stable position relative to the frame.

In one embodiment, the watch mechanism comprises two preloaded flexible second blades, the rigid piece being arranged to move in the main plane with a translational movement.

In one embodiment, the first and/or second flexible blade(s) comprise openings to reduce their flexural rigidity, lighten their weight and/or control their deformation.

In one embodiment, the rigid piece comprises openings to reduce its inertia and/or to activate a function.

In one embodiment, at least two parts selected from the following form a monobloc piece: the rigid piece, the first flexible blade, the second flexible blade and the frame.

In one embodiment, the watch mechanism comprises means for securing the rigid piece to the frame, these securing means comprising pins, screws and/or an additional flexible blade.

In one embodiment, the timepiece mechanism comprises a coupling mechanism, wherein when the rigid piece is in one stable position, it is arranged to activate the coupling mechanism to make an engagement, and when the rigid piece is in another stable position, it is arranged to deactivate the coupling mechanism to make a disengagement.

In one embodiment, the rigid piece is arranged to directly activate the coupling mechanism by coming into direct contact with the coupling mechanism.

In one embodiment, the rigid piece is arranged to indirectly activate the coupling mechanism.

In one embodiment, the coupling mechanism comprises a pin, the rigid piece comprises a housing arranged to receive the pin, in order to activate the coupling mechanism to perform a coupling.

In one embodiment, the first and/or second flexible blade(s) are substantially perpendicular to the main plane.

In one embodiment, the second flexible blades are parallel to each other. In one embodiment, the rigid piece comprises a clamp or U-shaped body.

In one embodiment, the rigid piece comprises a body of substantially polygonal or substantially rectangular shape.

In one embodiment, the coupling mechanism comprises a first clamp

portion, a second clamp portion, each clamp portion being arranged to pivot around an axis of rotation,
the first clamp portion comprising said pin,
the second clamp portion comprising a flexible blade, one end of which is connected to a hole of the frame.

In one embodiment, the rigid piece is a first rigid piece, the actuation device is a first actuation device,
the watch mechanism comprising:
a second actuating device,
a second rigid piece,
wherein
the second rigid piece is arranged to move in a second plane under the action of the second actuating device, from a first stable position (relative to the frame), to a second stable position (relative to the frame), the movement of the second rigid piece enabling a function, for example a reset function, to be performed.

In one embodiment, the pivoting piece is a first pivoting piece, the watch mechanism comprising:
a second pivoting piece, arranged to pivot under the action of the first actuating device or the second actuating device around an axis perpendicular to the main plane,
a first flexible blade and connecting the second rigid piece to the second pivoting piece,
a second flexible blade and connecting the second rigid piece to the frame, said mechanical pivot having a main axis offset in the main plane from the axis of rotation of the second pivoting piece,
the second pivoting piece being mounted on said mechanical pivot, thereby preloading the first flexible blade and the second flexible blade and rendering the second assembly formed by the second rigid piece, the first flexible blade and the second flexible blade bistable, so that
when the second pivoting piece rotates, said bistable second assembly moves in a second plane, from a first stable position (relative to the frame), to a second stable position (relative to the frame).

In one embodiment, the second plane is parallel to the main plane.

In one embodiment, the watch mechanism comprises a heart piece, the second rigid piece comprising at least one hammer portion, to actuate the heart piece.

According to an independent aspect, the invention relates to a watch mechanism comprising:
a first actuating device,
a second actuating device,
a first rigid piece,
a second rigid piece,
a frame,
wherein
the first rigid piece is arranged to move in a first plane under the action of the first actuating device, from a first stable position (relative to the frame), to a second stable position (relative to the frame), activating or performing a first function, and
the second rigid piece is arranged to move in a second plane substantially parallel to the first plane under the action of the second actuating device, from a first stable position (relative to the frame), to a second stable position (relative to the frame), activating or performing a second function different from the first.

In one embodiment, the first function is a coupling, and wherein the second function is a reset.

In one embodiment, the watch mechanism comprises in the first plane:
a first pivoting piece, arranged to pivot under the action of the first actuating device around a first axis perpendicular to the first plane,
a first preloaded flexible blade connecting the first rigid piece to the first pivoting piece,
a second preloaded flexible blade connecting the first rigid piece to the frame, wherein
the first pivoting piece is arranged to rotate under the action of the first actuating device, the first flexible blade and the second flexible blade, thereby displacing the first rigid piece in the first plane.

In one embodiment, the watch mechanism comprises in the second plane:
a second pivoting piece, connected to the first pivoting piece and arranged to rotate around a second axis perpendicular to the second plane,
a first preloaded flexible blade connecting the second rigid piece to the second pivoting piece,
a second preloaded flexible blade connecting the second rigid piece to the frame, wherein
the second pivoting piece is arranged to rotate under the action of the first actuating device or the second actuating device, the first flexible blade and the second flexible blade, thereby displacing the second rigid piece in the second plane.

In one embodiment, the first axis is the second axis.

In one embodiment, the first rigid piece is at least partially superimposed on the second rigid piece.

In one embodiment, the first pivoting piece is at least partially superimposed on the second pivoting piece.

In one embodiment, the watch mechanism comprises a heart piece, the second rigid piece comprising at least one hammer portion, to actuate the heart piece.

In one embodiment, the watch mechanism comprises a locking piece, for locking the second actuating device.

In one embodiment, the locking piece comprises a stopper, the second actuating device comprising a housing arranged to receive the stopper, thereby achieving a lock.

In one embodiment, the locking piece comprises a first and a second rigid portion, joined together by one or more flexible blades.

In one embodiment, the watch mechanism comprises an intermediate piece, arranged to cooperate with the second actuating device in order to move the second rigid piece.

In one embodiment, the intermediate piece is arranged to come into contact with the second actuating device and to rotate around its axis of rotation, as a result of this contact.

In one embodiment, the intermediate piece comprises a first pin, arranged to be received in an aperture created by the at least partial superposition of an aperture in the first rigid piece with a second aperture in the second rigid piece, and a second pin which is arranged to cooperate with a hammer portion of the second rigid piece.

According to an independent aspect, the invention relates to a watch mechanism comprising:
a first actuating device,
a second actuating device,
a first pivoting piece, arranged to cooperate with the first actuating device and to pivot around a first axis perpendicular to a first principal plane,
a second pivoting piece, arranged to be linked to the first pivoting piece and to pivot around a second axis perpendicular to a second principal plane,
a first flexible blade being connected to each pivoting piece,
a mechanical pivot having a main axis offset in the first main plane and/or in the second main plane from the axis of rotation of the first pivoting piece and the second pivoting piece,
the first pivoting piece and the second pivoting piece being mounted on said mechanical pivot, thereby preloading the first flexible blades.

In one embodiment, the watch mechanism comprises:
a frame,
and the first pivoting piece is arranged to rotate from a first stable position relative to the frame to a second stable position relative to the frame, under the action of the first actuating device and the first blade connected to the first pivoting piece,
the second pivoting piece is arranged to rotate from a first stable position relative to the frame to a second stable position relative to the frame, under the action of the first actuation device or the second actuation device, and under the action of the first blade connected to the second pivoting piece.

In one embodiment, the first pivoting piece is at least partially superimposed on the second pivoting piece.

In one embodiment, the first axis is the second axis.

In one embodiment, the first pivoting piece or the second pivoting piece is monobloc.

In one embodiment, the watch mechanism is arranged so that at least for one function of the watch mechanism, when the first pivoting piece rotates, the second pivoting piece remains stationary and vice versa.

In one embodiment, the first pivoting piece comprises a pin on said pivot, the second pivoting piece comprises an aperture, the pin being arranged to move in the aperture.

In one embodiment, each pivoting piece comprises an interaction portion, arranged to interact with the first actuating device.

In one embodiment, the second pivoting piece comprises a reset portion arranged to cooperate with the second actuating device.

In one embodiment, the watch mechanism comprises a third pivoting piece, which is superimposed on the second pivoting piece, the second pivoting piece being at least partially sandwiched between the first pivoting piece and the third pivoting piece.

In one embodiment, the first pivoting piece comprises a pin mounted on said pivot, the third pivoting piece comprises an aperture arranged to receive a free end of the pin of the first pivoting piece.

In one embodiment, the second pivoting piece comprises an end, which is arranged to cooperate with the pin of the first pivoting piece.

In one embodiment, the watch mechanism comprises a (second) pin connecting the first, second and third pivoting pieces.

In one embodiment, the watch mechanism comprises a push-lever, wherein in particular the first actuating device comprises a spring connected to the push-lever.

In one embodiment, the first respectively second pivoting pieces comprise through apertures, the second pin being inserted into these through apertures and one of its ends also being received in a through aperture of the push-lever.

In one embodiment, the rigid piece is arranged to move in the main plane with a rotational movement.

In one embodiment, the rigid piece comprises a pin and the coupling mechanism comprises a housing arranged to receive the pin, in order to activate the coupling mechanism to perform a coupling.

In one embodiment, the second rigid piece is arranged to move in a second plane different from the main plane, for example parallel to the main plane.

In one embodiment, the second rigid piece is arranged to move in the main plane.

In one embodiment, the first pivoting piece comprises a pin arranged to cooperate with the second pivoting piece, in particular to contact the second pivoting piece and cause it to pivot around its axis.

The described embodiments apply to the invention, including its independent aspects, and can be combined with each other.

### BRIEF DESCRIPTION OF FIGURES

Examples of implementation of the invention are shown in the description illustrated by the appended Figures in which:

FIG. 1 shows a perspective view of one embodiment of the watch mechanism according to the invention.

FIG. 2 illustrates a perspective view of another embodiment of the watch mechanism according to the invention.

FIG. 3A shows a top view of a part of a watch mechanism according to one embodiment of the invention, in a first stable position.

FIG. 3B shows a top view of the watch mechanism part of FIG. 3A, in a second stable position.

FIG. 4 shows a top view of a watch mechanism according to the invention, in the start phase.

FIG. 5 shows a top view of the watch mechanism of FIG. 4, in the stop phase.

FIG. 6 shows a top view of the watch mechanism of FIGS. 4 and 5, in the reset phase.

FIG. 7A shows a perspective view of a part of the watch mechanism according to one embodiment of the invention, in the phase prior to the start phase.

FIG. 7B shows a perspective view of the part of the watch mechanism of FIG. 7A, in the start phase.

FIG. 7C shows a perspective view of the part of the watch mechanism of FIG. 7A, in the stop phase.

FIG. 7D shows a perspective view of the part of the watch mechanism of FIG. 7A, in the reset phase.

FIG. 8 shows a perspective view of the first bistable of the watch mechanism according to another embodiment of the invention.

FIG. 9 shows a perspective view of the second bistable of the watch mechanism according to another embodiment of the invention.

FIG. 10 shows a perspective view of the first bistable of FIG. 8 and the second bistable of FIG. 9.

FIG. 11 shows a perspective view of the first bistable and second bistable assembly of FIG. 10, with a first device for actuating the watch mechanism according to another embodiment of the invention.

FIG. 12A shows a top view of the watch mechanism according to another embodiment of the invention, in the phase prior to the start phase.

FIG. 12B shows a bottom view of the watch mechanism of FIG. 12A.

FIG. 13A shows a top view of the watch mechanism of FIG. 12A, in the start phase.

FIG. 13B shows a bottom view of the watch mechanism of FIG. 13A.

FIG. 14A shows a top view of the watch mechanism of FIG. 12A, in the stop phase.

FIG. 14B shows a bottom view of the watch mechanism of FIG. 14A.

FIG. 15A shows a top view of the watch mechanism of FIG. 12A, in the reset phase.

FIG. 15B shows a bottom view of the watch mechanism of FIG. 15A.

FIG. 16A illustrates a top view of a portion (start and/or stop bistable) of the watch mechanism according to one embodiment, in which the flexible blades are not preloaded. FIG. 16B shows a top view of the mechanism of FIG. 16A, in which the flexible blades are preloaded. FIG. 16C is an overlay of FIGS. 16A and 16B.

FIG. 17A illustrates a top view of another portion (reset bistable) of the watch mechanism in one embodiment, in which the flexible blades are not preloaded. FIG. 17B shows a top view of the mechanism of FIG. 17A, in which the flexible blades are preloaded. FIG. 17C is an overlay of FIGS. 17A and 17B.

FIG. 18A shows a top view of a portion (start and/or stop bistable) of the watch mechanism in another embodiment, in which the flexible blades are not preloaded. FIG. 18B shows a top view of the mechanism of FIG. 18A, in which the flexible blades are preloaded. FIG. 18C is an overlay of FIGS. 18A and 18B.

FIG. 19A shows a top view of another portion (reset bistable) of the watch mechanism in another embodiment, in which the flexible blades are not preloaded. FIG. 19B shows a top view of the mechanism of FIG. 19A, in which the flexible blades are preloaded. FIG. 19C is an overlay of FIGS. 19A and 19B.

FIG. 20A illustrates a top view of a portion (start and/or stop bistable) of the watch mechanism according to one embodiment, in which the flexible blades are not preloaded. FIG. 20B shows a top view of the bistable of FIG. 20A, in which the flexible blades are preloaded. FIG. 20C is an overlay of FIGS. 20A and 20B.

FIG. 21A shows a top view of a portion (reset bistable) of the mechanism in another embodiment, in which the flexible blade is not preloaded. FIG. 21B shows a top view of the bistable of FIG. 21A, in which the flexible blade is preloaded. FIG. 21C is an overlay of FIGS. 21A and 21B.

FIG. 22A shows a top view of a mechanism in another embodiment, in the phase prior to the start phase. FIG. 22B shows a bottom view of the mechanism of FIG. 22A.

FIG. 23A shows a top view of the mechanism of FIG. 22A, in the reset phase. FIG. 23B shows a bottom view of the mechanism of FIG. 23A.

FIG. 24A shows a top view of the mechanism of FIG. 22A, in the start phase. FIG. 24B shows a bottom view of the mechanism of FIG. 24A.

FIG. 25A shows a top view of the mechanism of FIG. 22A, in the stop phase. FIG. 25B shows a bottom view of the mechanism of FIG. 25A.

FIG. 26A shows a perspective view of a portion of the mechanism of FIG. 22A, in the phase prior to the start phase.

FIG. 26B shows a perspective view of a portion of the mechanism of FIG. 22A, in the reset phase.

FIG. 26C shows a perspective view of a portion of the mechanism of FIG. 22A, in the start phase.

FIG. 26D shows a perspective view of a portion of the mechanism of FIG. 22A, in the stop phase.

### EXAMPLE(S) OF EMBODIMENT OF THE INVENTION

In the following description provided by way of example, reference will be made, for simplicity, to a watch mechanism for a chronograph watch. It should be understood, however, that the invention is not limited to such an application, but also includes any other watch application which requires the control or actuation of a function, for example and in a non-limiting way, it can be used in a flyback hand watch mechanism, a minute repeater watch mechanism, a countdown watch mechanism, etc.

In the context of the present application, the expression “flexible blade” refers to a blade or beam, arranged to deform elastically in a main plane of the watch mechanism according to the invention, for example according to a bending movement.

In the context of the present application, the term “bistable” refers to a watch component arranged to occupy two stable positions relative to a frame of the watch mechanism according to the invention, and which can be moved between these two stable positions.

In the context of the present application, the adjective “rigid” indicates that the component to which this adjective refers is not intended to be deformed during operation of the watch mechanism according to the invention, and has a rigidity greater than that of the flexible blades.

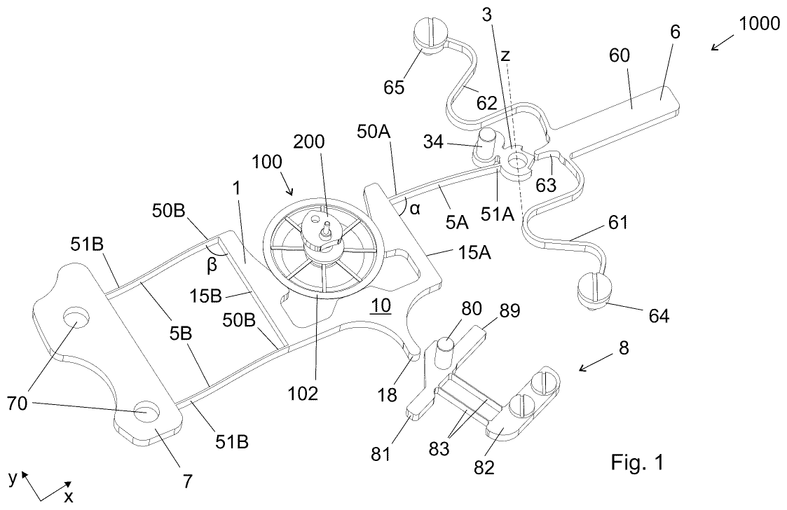

FIG. 1 illustrates a perspective view of one embodiment of the watch mechanism 1000 according to the invention. In this embodiment, the watch mechanism 1000 belongs to the main plane xy and comprises:
a first actuating device 6, for example a start and stop phase actuating device 6,
a pivoting piece 3, arranged to pivot under the action of the first actuating device 6 around an axis z perpendicular to the main plane xy,
a first frame 7,
a first rigid piece 1, arranged between the first frame 7 and the first pivoting piece 3,
a first flexible blade 5A connecting the first rigid piece 1 to the first pivoting piece 3,
two second flexible blades 5B connecting the first rigid piece 1 to the first frame 7, and
a locking piece 8, arranged to activate or prevent-as it will be seen-the resetting of the indicator associated with the heart piece 200 via a second actuating device 9. In other words, the locking piece 8 is arranged to lock the second actuating device 9, for example in the start phase.

The assembly of the first rigid piece 1, the first flexible blade 5A, and at least one second flexible blade 5B forms a first bistable.

The watch mechanism 1000 comprises a mechanical pivot (not shown) having a principal axis offset in the principal plane xy from the axis of rotation of the pivoting piece 3 in a non-preloaded or initial state, the pivoting piece 3 being mounted on this mechanical pivot. In one embodiment, the pin 34 of FIG. 1 is mounted on this pivot. In this case, the main axis of the pivot corresponds to the main axis of pin 34. The presence of this pivot guarantees the preloading of the flexible blades 5A, 5B.

The pivoting piece 3 therefore pivots around the mechanical pivot, which in the illustrated embodiment is fixed relative to the frame 7.

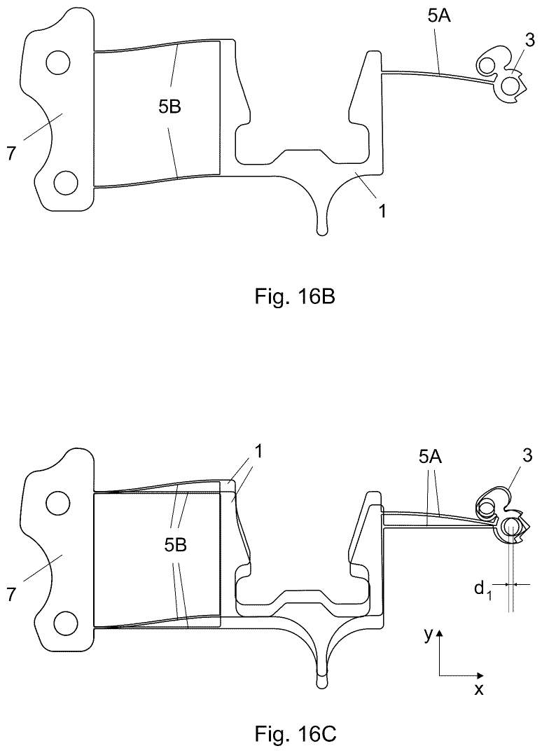

FIG. 16A shows a top view of the pivoting piece 3, the frame 7, the first rigid piece 1, the first flexible blade 5A and the two second flexible blades 5B, the flexible blades 5A and 5B not being preloaded.

FIG. 16B illustrates a top view of the mechanism of FIG. 16A, in which the flexible blades 5A and 5B are preloaded, as the pivoting piece 3 is mounted on a mechanical pivot (not shown) having a principal axis offset in the principal plane xy from the axis of rotation of the pivoting piece 3 in an non-preloaded state (that of FIG. 16A), the position of the frame 7 being the same in the non-preloaded (FIG. 16A) and preloaded (FIG. 16B) states. FIG. 16C, a superimposition of FIGS. 16A and 16B, illustrates the offset di between the two axes of rotation. In one embodiment, the offset di is less than one tenth of the length of the shortest flexible blade 5A, 5B.

The presence of the mechanical (rigid) pivot offset from the axis of the pivoting piece 3 in its non-preloaded or initial state makes the assembly of the first rigid piece 1 and the flexible blades 5A, 5B bistable. In other words, the same assembly is not bistable when the pivoting piece 3 is not mounted on the pivot, which preloads the blades 5A, 5B. In other words, the assembly is bistable through the preloaded flexible blades 5A, 5B thanks to this pivot offset from the axis of rotation of pivoting piece 3 in its non-preloaded or initial state.

The presence of the preloaded flexible blades 5A, 5B, thanks to this offset pivot, makes it possible to obtain a bistable assembly with a sufficiently long stroke (i.e. a path from one stable position to the other and vice-versa), enabling the watch mechanism according to the invention to be used also for a reset.

Thus, in the mechanism according to the invention, pivoting of the pivoting piece 3 causes deformation of the flexible blades 5A and 5B. This deformation causes a displacement (by translation in the case of FIG. 1) of the first rigid piece 1, and after this displacement a function (starting or stopping a chronograph in the case of FIG. 1) is executed.

When the pivoting piece 3 rotates, the assembly formed by the rigid piece 1 and the flexible blades 5A, 5B moves in the main plane xy, from a first stable position relative to the frame 7, to a second stable position relative to the frame 7.

In one embodiment, the pivoting piece 3 also rotates from a first stable position relative to the frame 7, to a second stable position relative to the frame 7. In one embodiment, when the pivoting piece 3 is in its first stable position, the bistable assembly is also in its first stable position, and when the pivoting piece 3 is in its second stable position, the bistable assembly is also in its second stable position. In this embodiment, in other words, the assembly formed by the rigid piece 1, the flexible blades 5A, 5B and the first pivoting piece 3 is also a bistable assembly.

The first actuating device 6 of the watch mechanism 1000 according to the invention moves, for example with a rotational and/or translational movement, under the action of a user of the watch (for example a wristwatch) comprising the watch mechanism 1000. Its displacement causes the pivoting piece 3 of the watch mechanism 1000 to pivot around the z-axis. The pivoting piece 3 is therefore an interacting piece, as it interacts, directly or indirectly, with the first actuating device 6.

The actuating device 6 can be designed in a number of different ways, and the embodiment of FIG. 1 is not intended to be restrictive. The actuating device 6 may, for example, be monobloc or comprise several components, interconnected by removable or non-removable connecting means. Actuating device 6 may, for example, comprise flexible blades or be devoid of such blades. The actuating device 6 may, for example, move in rotation and/or translation.

In this context, the adjective “monobloc” indicates that the component to which it refers is monolithic.

In the embodiment of FIG. 1, the actuating device 6 is monobloc and comprises a main body 60, in particular a rigid main body, which is connected on both sides to two flexible blades 61, 62. In the embodiment of FIG. 1, each flexible blade is “S”-shaped and terminates with an end 64 respectively 65 at which the actuating device 6 is connected to a frame (not shown). The first actuating device 6 in FIG. 1 moves with a roto-translational motion.

In the embodiment of FIG. 1, the actuating device 6 comes into direct contact with the first pivoting piece 3. In particular, it comprises a projecting contact portion 63, which comes into contact with the first pivoting piece 3. However, a direct contact between the actuating device 6 and the first pivoting piece 3 is not essential, provided that the actuating device 6 causes (directly or indirectly) the pivoting piece 3 to pivot around the z-axis.

As the pivoting piece 3 pivots around the z axis, the preloaded flexible blades 5A and 5B deform, actuating the first rigid piece 1 and causing it to move in the main plane xy.

Although in the embodiment of FIG. 1 there are two second flexible blades 5B connecting the first rigid piece 1 to the first pivoting piece 3, the watch mechanism according to the invention could also operate with a single flexible blade 5B. However, the presence of two second flexible blades 5B makes it easier to control the movement of the first rigid piece 1, which in particular performs a translational movement in the main plane xy, especially along the y direction.

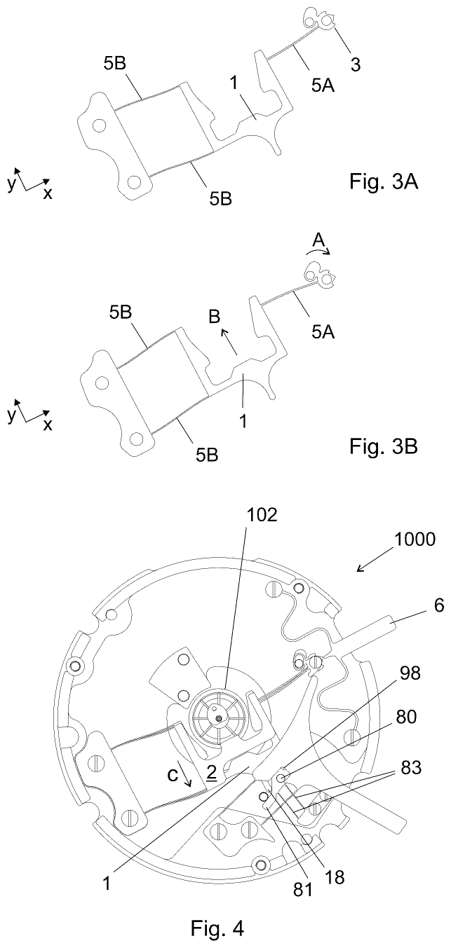

Each flexible blade 5A and 5B is preloaded, i.e. it is deformed when mounted in the watch mechanism 1000, for example visible in FIG. 3A, which illustrates a top view of a part of a watch mechanism 1000 according to an embodiment of the invention, at rest, in a first stable position. The preloading of each flexible blade 5A and 5B is linked to the presence of the mechanical pivot having a main axis offset in the main plane xy from the axis of rotation of the pivoting piece 3. In one embodiment, each flexible blade 5A and 5B is preloaded by deforming it in the xy plane.

Thanks to the preloading of the flexible blades 5A and 5B, the movement of the first rigid piece 1 also causes the flexible blades 5A and 5B to deform as a result of the pivoting of the pivoting piece 3, enabling both the first rigid piece 1 and the pivoting piece 3, as well as each flexible blade 5A and 5B, to move from a first stable position to a second stable position, illustrated in FIG. 3B. In particular, the first rigid piece 1 moves from the first stable position in FIG. 3A to the second stable position in FIG. 3B with a translational movement in the direction of arrow B, thanks to the presence of two second flexible blades 5B. The pivoting piece 3 moves from the first stable position in FIG. 3A to the second stable position in FIG. 3B with a rotational movement in the direction of arrow A.

Returning to the embodiment of FIG. 1, each flexible blade 5A and 5B has a height in a direction parallel to the z axis, which is at least five times greater than its thickness in the xy plane, and which is at least ten times smaller than its length in a direction substantially parallel to the x axis. The aspect ratio of each flexible blade 5A and 5B defines its flexibility in the plane of interest.

Each flexible blade 5A and 5B can be substantially perpendicular to the main plane xy, i.e. its height can be substantially perpendicular to the main plane xy, as illustrated in the embodiment of FIG. 1.

The first flexible blade 5A, in particular its first end 50A which is connected to the first rigid piece 1, can also be substantially perpendicular to a first lateral surface 15A of the first rigid piece 1. In particular, it can form an angle a which, at rest, is in the 80°-100° range, in particular in the 85°-95° range, for example in the 87°-93° range, as illustrated in the embodiment of FIG. 1. This inclination introduces an asymmetry in the behavior of the bistable assembly formed by the rigid piece 1 and the blades 5A, 5B. In the case of perpendicularity (a approximately equal to) 90°, the stroke of the bistable assembly during its translational movement is the same regardless of the direction of movement. Otherwise (a not equal to) 90°, the stroke is no longer the same if the bistable assembly moves from a first stable position to a second stable position with respect to the opposite direction (i.e., when the bistable assembly moves from the second stable position to the first stable position). The total stroke between the stable position and the jump moment (the moment of change of state, when the mechanism tends to move towards the other stable position and not back), i.e. the total stroke between the two stable positions, remains substantially the same.

The first flexible blade 5A can be connected to the first rigid piece 1 at a non-central (or peripheral) position of the first lateral surface 15A of the first rigid piece 1, as illustrated in the embodiment of FIG. 1.

The first flexible blade 5A also has a second end 51A, opposite the first end 50A, which is connected to the pivoting piece 3.

In one embodiment, the first flexible blade 5A can be a separate piece from the pivoting piece 3 and the first rigid piece 1, and is connected to the pivoting piece 3 and the first rigid piece 1 respectively by known, removable or non-removable connecting means.

In another embodiment, the first flexible blade 5A can form a monobloc piece with the pivoting piece 3 and/or the first rigid piece 1.

In one embodiment (not illustrated), the watch mechanism 1000 comprises two (or more) first flexible blades 5A. In one embodiment (not illustrated), at least some of these first flexible blades 5A are parallel to each other.

In the case where the watch mechanism comprises two (or more) second flexible blades 5B, at least some of these second flexible blades 5B are parallel to each other, as illustrated, for example, in FIG. 1.

Each second flexible blade 5B, in particular its end 50B which is connected to the first rigid piece 1, can also be substantially perpendicular to a second lateral surface 15B of the first rigid piece 1. In particular, it can form an angle β which at rest belongs to the range 80°-100°, in particular to the range 85°-95°, for example to the range 87°-93°, as illustrated in the embodiment of FIG. 1.

In the case of non-perpendicularity (β different from) 90°, the bistable assembly formed by rigid piece 1 and blades 5A, 5B has different kinematics to a perpendicular bistable assembly in which β is substantially equal to 90°. For example, if β=87°, it is possible to create an asymmetry in the kinematics of the bistable assembly, which can be used during the reset.

Each second flexible blade 5B can be connected to the first rigid piece 1 at a peripheral position of the second side surface 15B of the first rigid piece 1, as illustrated in the embodiment of FIG. 1.

Each second flexible blade 5B also comprises a second end 51B, opposite the first end 50B, which is connected to a frame 7.

In one embodiment, the second flexible blade 5B can be a separate piece from the first rigid piece 1 and from the frame 7, and connected to the first rigid piece 1 respectively to the frame 7 with known, removable or non-removable connecting means.

In another embodiment, the second flexible blade 5B can form a monobloc piece with the first rigid piece 1 and/or the frame 7.

In one embodiment, at least some of the flexible blades 5A and/or 5B comprise one or more recesses or (through) openings 55A respectively 55B, for example in the xz plane, enabling to reduce their bending rigidity (and therefore the stresses in the material), to lighten their weight and/or to (better) control their deformation. In one embodiment, these openings have a rectangular or polygonal shape, but any other shape can be envisaged.

Although in the embodiment of FIG. 1, the first flexible blade 5A and the second flexible blades 5B project from the first rigid piece 1 on a first side respectively on a second side opposite to the first, in another embodiment they project from the first rigid piece 1 on the same side.

In one embodiment, the watch mechanism 1000 comprises two or more first flexible blades 5A in series, and (at least) one additional rigid piece (not shown) connecting two consecutive first flexible blades 5A. In one embodiment, all the first flexible blades 5A and the additional rigid piece(s) form a monobloc piece.

In one embodiment, the watch mechanism 1000 comprises several second flexible blades 5B in series, and (at least) one additional rigid piece (not shown) connecting two consecutive second flexible blades 5A. In one embodiment, all the second flexible blades 5A and the additional rigid piece(s) form a monobloc piece.

In one embodiment, the watch mechanism 1000 comprises a coupling mechanism 100. Although in the example of FIG. 1, this coupling mechanism 100 is a coupling mechanism comprising a coupling intermediate wheel 101 and a flange 102, this embodiment should not be considered restrictive: the watch mechanism 1000 may comprise another type of coupling mechanism 100, for example a horizontal coupling mechanism, a coupling mechanism with an oscillating pinion, etc.

In the embodiment of FIG. 1, the coupling mechanism 100 is coaxial with a heart piece 200, connected to an indicator (not shown), for example a time-keeping indicator.

In one embodiment, when the first rigid piece 1 is in a first stable position, it activates the coupling mechanism in order to perform a coupling, and when it is in a second stable position, it deactivates the coupling mechanism in order to perform a decoupling. If the watch mechanism 1000 is used in a chronograph watch, the first rigid piece 1 enables start/stop functions to be activated. In particular, the start/stop functions are performed after the first rigid piece 1 has been moved.

Activation of the coupling mechanism 100 by the first rigid piece 1 can be achieved in various ways, directly or indirectly, for example and without limitation by contact, pinching, displacement, etc.

The body 10 of the first rigid piece 1 may be clamp-shaped or U-shaped, as in the example of FIG. 1. This shape does not necessarily imply that the first rigid piece 1 clamps the coupling mechanism 100, in order to activate it.

In another embodiment, the watch mechanism comprises several coupling mechanisms 100 and the first rigid piece 1 is arranged to activate these coupling mechanisms.

In one embodiment, the first rigid piece 1 comprises one or more recesses or (through) openings, for example openings in the xy plane, in order to reduce its inertia and/or in order to activate a function. In one embodiment, these openings have a rectangular or polygonal shape, but any other shape can be envisaged.

The first rigid piece 1 may comprise (at least) one projection 18 which can cooperate with the first rigid portion 81 of the locking piece 8. In the example of FIG. 1, the stopper 80 belongs to the locking piece 8, arranged to lock the second actuating device 9, as will be seen later.

In one embodiment, the first rigid piece 1 is a monobloc piece.

In one embodiment, the first rigid piece 1 forms a monobloc piece with the first flexible blade 5A and/or the second flexible blade 5B.

The frame 7 may comprise one or more (through) holes 70, in order to attach it to a bridge or plate of a movement comprising the watch mechanism 1000 according to the invention, for example via screws (not of FIG. 1). However, the frame 7 can be attached to a bridge or plate by other means, for example via one or more pins, such as pins on pivots (not shown). The use of pivots makes it possible to reduce stresses in the blades 5A, 5B, which are high and can cause mechanical failure. It also makes it possible to increase the thickness of blades 5A, 5B, while maintaining acceptable stresses and therefore the force either to actuate the coupling, or to return the heart piece 200 to its initial position.

The frame 7 can be attached to a bridge or a plate, for example, also via one or more additional flexible blades (not shown), placed between blades 5A and/or 5B and frame 7, which also enable stresses in the material of blades 5A, 5B to be reduced when moving from one stable position to another, thus enabling blades 5A, 5B to be widened in the xy plane, in order to increase the strength of the bistable assembly to activate functions more easily and/or improve shock resistance. In one embodiment, these additional flexible blades form an angle differing from 180° with blades 5A and/or 5B.

The locking piece 8 may comprise a first rigid portion 81 and a second rigid portion 82, connected together by one or more flexible blades 83. The stopper 80 may belong to one rigid portion, for example to the first rigid portion 81, as of FIG. 1. If the two rigid portions 81, 82 are connected by two or more flexible blades 83, at least some of them may be parallel, as of FIG. 1.

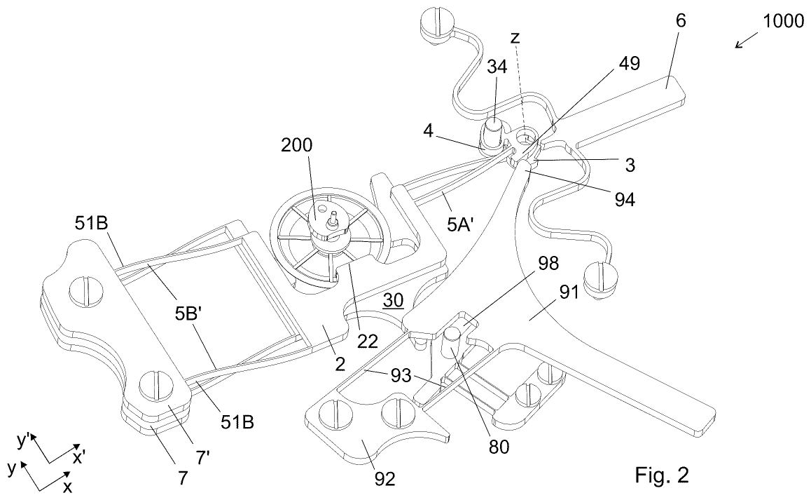

FIG. 2 illustrates a perspective view of another embodiment of the watch mechanism 1000 according to the invention, comprising, in addition to the components illustrated on FIG. 1:
a second pivoting piece 4, connected to the first pivoting piece 3 (e.g. via a pin 34 mounted on the pivot according to the invention), and arranged to pivot also around an axis z,
a second frame 7′,
a second rigid piece 2, arranged between the second frame 7′ and the second pivoting piece 4,
a first flexible blade 5A′ and connecting the second rigid piece 2 to the second pivoting piece 4,
two second flexible blades 5B′ and connecting the second rigid piece 2 to the second frame 7′, and
a second actuating device 9, for example an actuating device for resetting the indicator associated with the heart piece 200.

In one embodiment, the second rigid piece 2 and the flexible blades 5A′, 5B′ together form a second bistable assembly.

In one embodiment, the second pivoting piece 4 is also mounted on the same mechanical pivot of the first pivoting piece 3, and the main axis of the mechanical pivot (which may correspond to the main axis of the pin 34) is offset in the x′y′ plane also with respect to the axis of rotation of the second pivoting piece 4 in a non-preloaded or initial state. Indeed, in the illustrated embodiment, the axis of rotation of the second pivoting piece 4 corresponds to the axis of rotation of the first pivoting piece 3. This ensures that both flexible blades 5A′, 5B′ are preloaded.

Pivoting piece 4 therefore pivots around the mechanical pivot, which in the illustrated version is fixed relative to frame 7′.

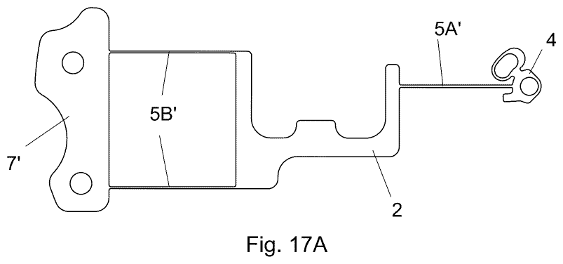

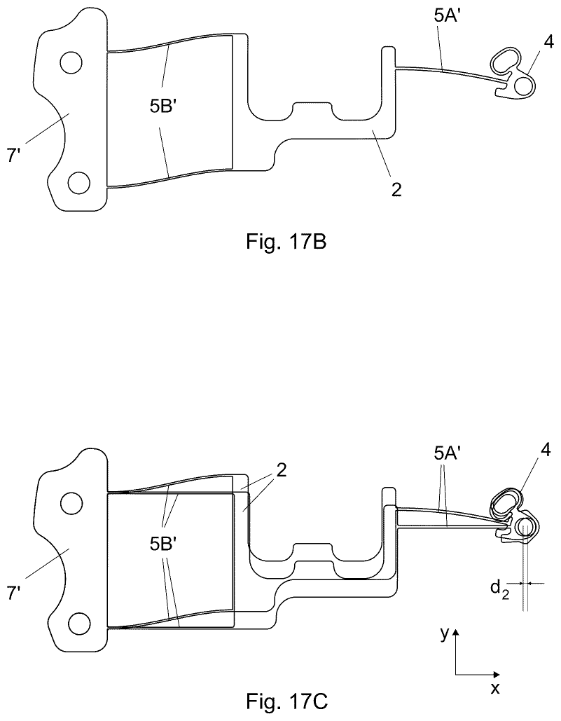

FIG. 17A shows a top view of the pivoting piece 4, the frame 7′, the second rigid piece 2, the first flexible blade 5A′ and the two second flexible blades 5B′, the flexible blades 5A′ and 5B′ being not preloaded.

FIG. 17B shows a top view of the mechanism of FIG. 17A in which the flexible blades 5A′ and 5B′ are preloaded, because the pivoting piece 4 is mounted on a mechanical pivot (not shown) having a principal axis offset in the principal plane xy from the axis of rotation of the pivoting piece 4 in a non-preloaded state (that of

FIG. 17A), the position of the frame 7′ being the same in the non-preloaded (FIG. 17A) and preloaded (FIG. 17B) states. FIG. 17C, a superimposition of FIGS. 17A and 17B, illustrates the offset d₂ between the two axes of rotation. In one embodiment, the offset d₂ is less than one tenth of the length of the shorter flexible blade 5A′, 5B′.

The presence of the mechanical (rigid) pivot offset from the axis of pivoting piece 4 makes the assembly of second rigid piece 2 and blades 5A′, 5B′ bistable. In other words, the same assembly is not bistable when the pivoting piece 4 is not mounted on the pivot, which preloads the blades 5A′, 5B′.

When the second pivoting piece 4 rotates, the assembly formed by the second rigid piece 2 and the blades 5A′, 5B′ moves in a plane, from a first stable position relative to the frame 7 to a second stable position relative to the frame 7.

In one embodiment, the second pivoting piece 4 also rotates from a first stable position relative to the frame 7, to a second stable position relative to the frame 7. In one embodiment, when the second pivoting piece 4 is in its first stable position, the bistable assembly formed by the second rigid 2 and the blades 5A′, 5B′ is also in its first stable position, and when the second pivoting piece 4 is in its second stable position, this bistable assembly is also in its second stable position. In other words, the assembly formed by the second rigid piece 2, the blades 5A′, 5B′ and the second pivoting piece 4 is also a bistable assembly.

In one embodiment (not shown), the flexible blades 5A and 5B, the first rigid piece 1, the first pivoting piece 3 and the first frame 7, as well as the flexible blades 5A′ and 5B′, the second rigid piece 2, the second pivoting piece 4 and the second frame 7′ all belong to the same xy plane. In other words, in this embodiment, the first bistable assembly and the second bistable assembly are coplanar.

In one embodiment (not shown), the first bistable assembly and the second bistable assembly belong to two planes inclined to each other.

In one embodiment, an example of which is of FIG. 2, the first bistable assembly and the second bistable assembly belong to two parallel planes, xy and x′y′.

Although in the embodiment of FIG. 2, the x′y′ plane is above the xy plane, this embodiment is not limiting and, in another embodiment, (not shown), the x′y′ plane may be below the xy plane.

In one embodiment, the xy plane is that of a first planar plate and the x′y′ plane is that of a second planar plate.

In one embodiment, each of the first plate and the second plate can be produced by photolithography from a wafer, e.g. a silicon wafer, by laser cutting, by LIGA (for “Rontgenlithographie, Galvanoformung und Abformung”), etc. In one embodiment, at least one of the first and second plates is made of a composite material comprising a forest of juxtaposed nanotubes held together by a matrix. In one variant, the nanotubes are carbon nanotubes. In one variant, the matrix comprises amorphous carbon. In other variants, the nanotubes are made of other materials, for example boron nitride nanotubes (BNNT) or silicon. In one variant, at least one of the first and second plates is made of steel. In another variant, at least one between the first plate and the second plate is made of glass, sapphire or alumina, diamond, in particular synthetic diamond (in particular synthetic diamond obtained by a chemical vapor deposition process), titanium, titanium alloy (in particular an alloy from the Gum metal (R) family) or an alloy from the elinvar family, in particular Elinvar (R), Nivarox (R), Thermelast (R), NI-Span-C (R) and Precision C (R), shape memory alloy, in particular Nitinol, or plastic.

In one embodiment, the second pivoting piece 4 is arranged to rotate under the action of the first actuating device 6, so as to deform the first blade 5A′ and the second blade 5B′, moving the second bistable (i.e. the second rigid piece 2, together with each flexible blade 5A′ and 5B′) in the x′y′ plane, from a first stable position relative to the second frame 7′, to a second stable position relative to the second frame 7′, performing a second function, different from the first performed by moving the first bistable (i.e. the first rigid piece 1 and the blades 5A, 5B).

In one embodiment, the displacement of the first bistable activates a coupling and displacement of the second bistable resets an indicator associated with the heart piece 200.

In one embodiment, for at least one function of the watch mechanism 1000 according to the invention, when the first bistable assembly moves, the second bistable assembly remains stationary and vice versa. In one embodiment, at stop, only the first bistable assembly moves, and at reset, only the second bistable assembly moves.

In one embodiment, for at least one other function of the watch mechanism 1000 according to the invention, when the first bistable assembly moves, the second bistable assembly also moves. In one embodiment, at the start, both bistable assemblies move.

In one embodiment, for at least one function of the watch mechanism 1000 according to the invention, when the first pivoting piece 3 rotates, the second pivoting piece 4 remains stationary and vice versa. In one embodiment, at stop, only the first pivoting piece 3 moves, and at reset, only the second pivoting piece 4 moves.

In one embodiment, for at least one other function of the watch mechanism 1000 according to the invention, the first pivoting piece 3 rotates, and the second pivoting piece 4 also moves. In one embodiment, at the start, both pivoting pieces 3, 4 move.

In one embodiment, for at least one function of the watch mechanism 1000 according to the invention, the first rigid piece 1 is at least partially superimposed on the second rigid piece 2, as illustrated, for example, in FIG. 2. In another embodiment (not shown), the first rigid piece 1 is not superimposed on the second rigid piece 2.

In one embodiment, for at least one function of the watch mechanism 1000 according to the invention, the first flexible blade 5A is at least partially superimposed on the first flexible blade 5A′, and/or the second flexible blade 5B is at least partially superimposed on the second flexible blade 5B′.

Although in the embodiment of FIG. 2, the body 20 of the second rigid piece 2 also has a U-shape like that of the first rigid piece 1, in other embodiments it does not have the same or similar shape. In other embodiments, it also does not have the same or similar dimensions.

Although in the embodiment of FIG. 2, the first flexible blade 5A has a similar shape and dimensions to the flexible blade 5A′, in other embodiments the two first blades 5A and 5A′ are not equal or similar in shape and dimensions.

Although in the embodiment of FIG. 2, the second flexible blades 5B have a similar shape and dimensions to the flexible blades 5B′, in other embodiments the second blades 5B and 5B′ are not equal or similar in shape and dimensions.

The considerations made above with reference to FIG. 1 for the first flexible blade 5A and the second flexible blade 5B apply mutatis mutandis to the first flexible blade 5A′ respectively to the second flexible blade 5B′.

The considerations made above with reference to FIG. 1 for the first frame 7 apply mutatis mutandis to the second frame 7′.

In one embodiment, the first frame 7 and the second frame 7′ form a monobloc piece. In another embodiment, the first frame 7 is connected to the second frame 7′ by removable or non-removable connecting means.

In one embodiment, when the second rigid piece 2 is in a stable position, it activates the reset of the indicator (not shown) associated with the heart piece 200. If the watch mechanism 1000 is used in a chronograph watch, the second rigid piece 2 is therefore, together with the blades 5A′ and 5B′, a reset bistable. The reset function is performed after the second rigid piece 2 has been moved.

The second rigid piece 2 may comprise (at least) one hammer portion 22 which can cooperate with the heart piece 200, an acting as a known hammer during the reset phase, as will be seen later.

Activation of the reset by the second rigid piece 2 can be achieved in various ways, directly or indirectly, for example and in a non-limiting way, by (direct or indirect) contact of the hammer portion 22 with the heart piece 200.

The second rigid piece 2 may be clamp-shaped or U-shaped, as in the example of FIG. 2.

In another embodiment, the watch mechanism comprises several heart pieces 200 and the second rigid piece 2 is arranged to activate these heart pieces 200, for example with several hammer portions 22.

In one embodiment, the second rigid piece 2 comprises one or more recesses or (through) openings, for example openings in the x′y′ plane, to reduce its inertia and/or in order to be able to activate a function. In one embodiment, these openings have a rectangular or polygonal shape, but any other shape can be envisaged.

In one embodiment, the second rigid piece 2 is a monobloc piece part.

In one embodiment, the second rigid piece 2 forms a monobloc piece with the first flexible blade 5A′ and/or the second flexible blade 5B′.

In one embodiment, the second pivoting piece 4 is arranged to cooperate with the first actuating device 6 and to pivot around a second axis perpendicular to the xy and x′y′ planes.

In one embodiment, this second axis corresponds to the axis of rotation z of the first pivoting piece, as of FIG. 2.

In one embodiment, the first pivoting piece 3 is at least partially superimposed on the second pivoting piece 4, as of FIG. 2.

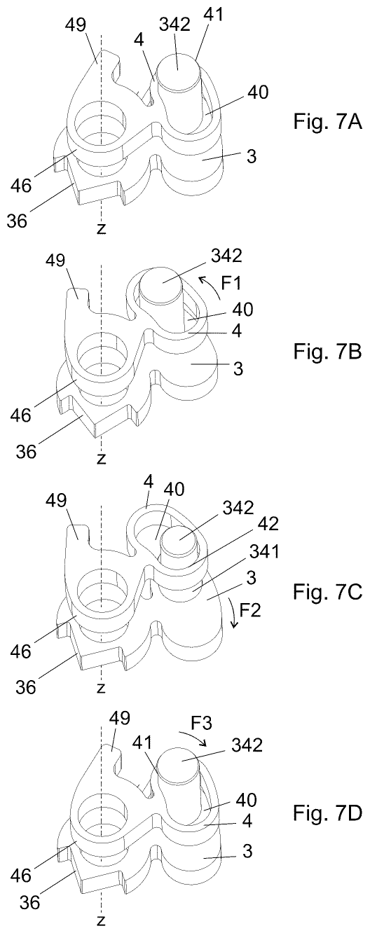

In one embodiment, the watch mechanism 1000 comprises the pin 34 on (rigid) mechanical pivot, or other connecting means on (rigid) mechanical pivot, a first end 341 of which is connected to the first pivoting piece 3 and the second end 342 of which, which is opposite the first end 341, is received in a through opening 40 of the second pivoting piece 4, as best seen in FIGS. 7A to 7D, which illustrate a perspective view of the first and second pivoting pieces 3, 4 in the pre-start phase, in the start phase, in the stop phase, respectively in the reset phase. In particular, the second end 342 can move into the through-opening 40 of the second pivoting piece 4.

In one embodiment, each pivoting piece 3, 4 comprises an interaction portion 36 respectively 46, arranged to interact (directly or indirectly) with an actuating device. In the example of FIGS. 7A and 7C, these interaction portions 36, 46 have a substantially triangular shape, but any other shape can be envisaged. The interaction portions 36, 46 need not necessarily have the same shape.

Although in the embodiment of FIG. 2, the same actuating device 6 actuates each pivoting piece 3, 4 at the same time, in another embodiment each pivoting piece 3, 4 is actuated by a separate actuating device, e.g. the pivoting piece 3 is actuated by a start actuating device and pivoting piece 4 is actuated by a stop actuating device.

In one embodiment, each pivoting piece 3, 4 also comprises a portion (not referenced in the Figures) at which it is linked to the first flexible blade 5A respectively 5A′.

In one embodiment, the second pivoting piece 4 comprises a reset portion 49, visible for example in FIGS. 7A to 7D, arranged to cooperate (directly as visible in FIG. 2, or indirectly) with the second actuating device 9.

In one embodiment, the reset portion 49 is a projection of the second pivoting piece 4.

The second actuating device 9 may comprise a first rigid portion 91 and a second rigid portion 92, connected by one or more flexible blades 93. If the two rigid portions 91, 92 are connected by two or more flexible blades 93, at least some of them may be parallel, as illustrated in FIG. 2.

The second actuating device 9 may comprise an interaction portion 94, arranged to interact (directly as seen in FIG. 2, or indirectly) with the reset portion 49 of the second pivoting piece 4.

The second actuating device 9 may comprise a housing 98 arranged to receive the stopper 80.

FIGS. 4 to 6 show a top view of a watch mechanism according to the invention, in the start, stop and reset phases.

Before actuating the actuating device 6, the first and second pivoting pieces 3, 4 are (at least partially) superimposed, as of FIG. 7D. The second end 342 of pin 34 rests against a first wall 41 of through-opening 40.

When the actuating device 6 is activated, it causes both the first and second pivoting pieces 3, 4 to rotate around the z-axis, in the direction of arrow F1 in FIG. 7B.

The pivoting of the first pivoting piece 3 causes the preloaded flexible blades 5A and 5B to move the first piece 1 and the blades 5A, 5B to a first stable position, e.g. by translation along the direction of arrow C visible in FIG. 4, to produce a coupling. In the embodiment of FIG. 4, this first stable position is away from the flange 102, so that the coupling intermediate wheel 101 contacts the flange 102. Once the first piece 1 has moved, the indicator (not shown) connected to the flange 102 starts to rotate (start phase).

In this start phase, the second rigid piece 2 is preloaded by means of pin 34 between the first and second pivoting pieces 3, 4.

In this start phase, the displacement of the first piece 1 causes the first rigid portion 81 of the locking piece 8 to move via the projection 18. As a result of this displacement, the flexible blades 83 of the locking piece 8 deform, enabling the stopper 80 to be received in the housing 98 of the second actuating device 9, thus blocking its movement. In this start phase, therefore, it is not possible to activate the reset of the indicator associated with the heart piece 200.

The locking piece 8 is not necessary for the operation of the watch mechanism: for example, it may be absent if the watch mechanism 1000 is used in a “flyback” chronograph, where it is not necessary to make a “stop” before “resetting”.

Actuating the first actuating device 6 again (or actuating another actuating device not shown) only causes the first pivoting piece 3 to pivot in a direction F2 opposite to that F1 at the start, as of FIG. 7C. The second pivoting piece 4 does not move. As a result of the pivoting of the first pivoting piece 3, the second end 342 of the pin 34 rests against the second wall 42 of the opening 40, opposite the first wall 41.

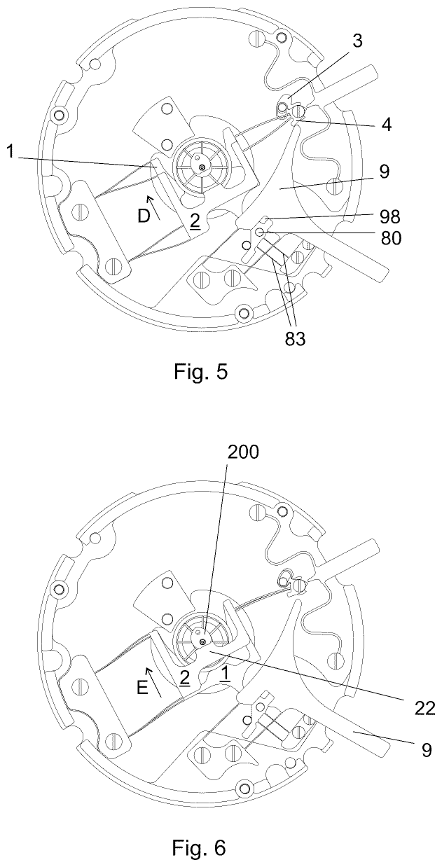

The pivoting of the first pivoting piece 3 causes, by means of the preloaded flexible blades 5A and 5B, a displacement, for example by translation along the direction of arrow D visible in FIG. 5 (and opposite to the direction of arrow C in FIG. 4), of the first piece 1 towards a second stable position, to interrupt the coupling. In the embodiment of FIG. 5, this second stable position lifts the flange 102, so that the coupling intermediate wheel 101 no longer contacts the flange 102. Once the first piece 1 has moved, the indicator (not shown) connected to the flange 102 stops (stop phase).

In this stop phase, the second rigid piece 2 remains preloaded by means of pin 34 between the first and second pivoting pieces 3, 4.

In this stop phase, the displacement of the first rigid piece 1 stops the interaction of the projection 18 with the first rigid portion 81 of the locking piece 8. The flexible blades 83 of the locking piece 8 deform again, allowing the stopper 80 to move out of the housing 98 of the second actuating device 9, thus releasing the locking piece 8 from the second actuating device 9. The second actuating device 9 can then be actuated, to reset the indicator associated with the heart piece 200.

Actuating the second actuating device 9 now only causes the second pivoting piece 4 to pivot in a direction F3 which is the same as the direction F2 in which the first pivoting piece 3 pivots at stop, as of FIG. 7D. In this embodiment, the second actuating device 9 acts directly on the second pivoting piece 4.

When the second actuating device 9 is actuated, the first pivoting piece 3 does not move. As a result of the pivoting of the second pivoting piece 4, the second end 342 of the pin 34 is again in contact with the first wall 41 of the opening 40, opposite the second wall 42.

The pivoting of the second pivoting piece 4 causes the preloaded flexible blades 5A′ and 5B′ to move the second piece 2, for example by translation along the direction of arrow E visible in FIG. 5 (which corresponds to the direction of arrow D in FIG. 5), into a second stable position, thereby actuating the heart piece 200 via the hammer portion 22. Once the second piece 2 has been moved, the indicator is reset.

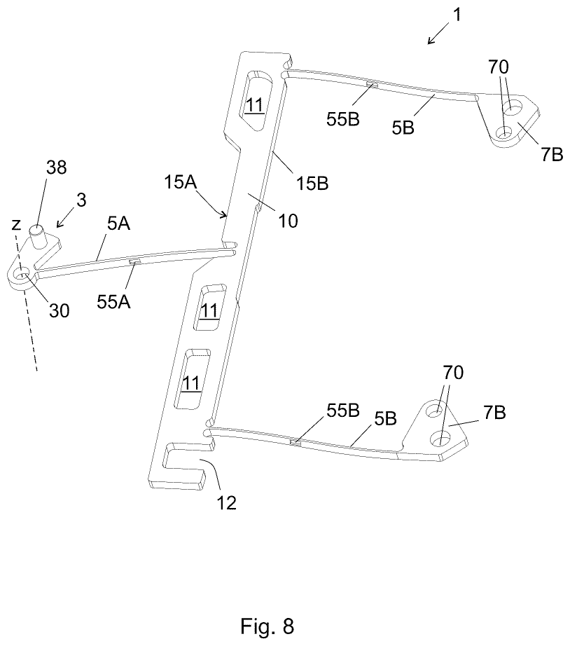

FIG. 8 shows a perspective view of the first rigid piece 1 of the watch mechanism according to another embodiment of the invention.

Also in this embodiment, the watch mechanism 1000 comprises a mechanical pivot (not shown) having a principal axis offset in the principal plane xy from the axis of rotation of the pivoting piece 3 in a preloaded or initial state, the pivoting piece 3 being mounted on this mechanical pivot. This preloads the first flexible blade 5A and the second flexible blades 5B and makes the assembly formed by the rigid piece 1, the first flexible blade 5A and the second flexible blade 5B bistable. In one embodiment, the pin 38 (or any other rigid connecting means) is mounted on this pivot.

The pivoting piece 3 therefore pivots around the mechanical pivot, which in the illustrated embodiment is fixed relative to frame 7B.

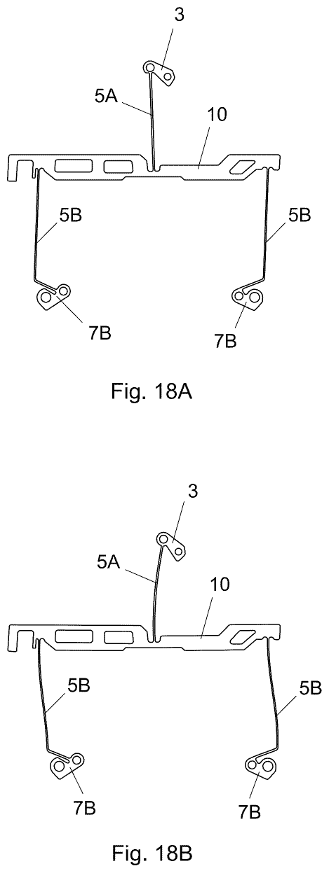

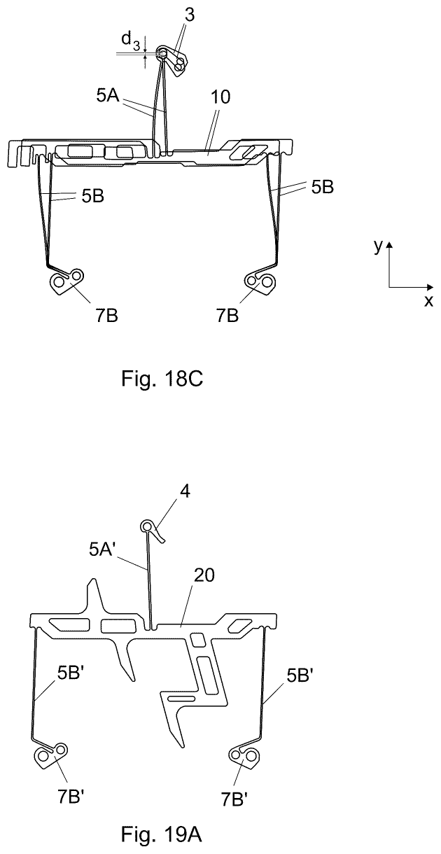

FIG. 18A shows a top view of the pivoting piece 3, the frame 7B, the body 10 of the first rigid piece 1, the first flexible blade 5A and the two second flexible blades 5B, the flexible blades 5A and 5B not being preloaded.

FIG. 18B shows a top view of the mechanism of FIG. 18A, in which the flexible blades 5A and 5B are preloaded, as the pivoting piece 3 is mounted on a mechanical pivot (not shown) having a main axis offset in the main plane xy from the axis of rotation of the pivoting piece 3 in a non-preloaded state (that of FIG. 18A), the position of the frame 7B being the same in the non-preloaded (FIG. 18A) and preloaded (FIG. 18B) states. The presence of the (rigid) mechanical pivot offset from the axis of the pivoting piece 3 in its non-preloaded or initial state makes the assembly of the first rigid piece 1 and the flexible blades 5A, 5B bistable. In other words, the same assembly is not bistable when the pivoting piece 3 is not mounted on the pivot, which preloads the blades 5A, 5B. FIG. 18C, a superimposition of FIGS. 18A and 18B, illustrates the offset between the two axes of rotation. In one embodiment, the offset d₃ is less than one tenth of the length of the shortest flexible blade 5A, 5B.

In this embodiment, the body 10 of the first rigid piece 1 has a polygonal, substantially rectangular shape. It comprises several through openings 11 of different shapes (e.g. triangular, trapezoidal, etc.), to reduce its inertia and/or to activate a function.

In this embodiment, the first rigid piece 1 comprises a housing 12 which is arranged to cooperate with a coupling mechanism, as will be seen later.

In this embodiment, the first flexible blade 5A can be connected to the first rigid piece 1 at a central position of the lateral surface 15A of the first rigid piece 1.

In this embodiment, each second flexible blade 5B can be connected to the first rigid piece 1 at a peripheral position of a second side surface 15B of the first rigid piece 1.

In this embodiment, the flexible blades 5A and 5B comprise one or more recesses or (through) openings 55A and 55B respectively, in order to reduce their flexural rigidity, lighten their weight and/or better control their deformation. In this embodiment, these openings have a rectangular shape, but any other shape can be envisaged.

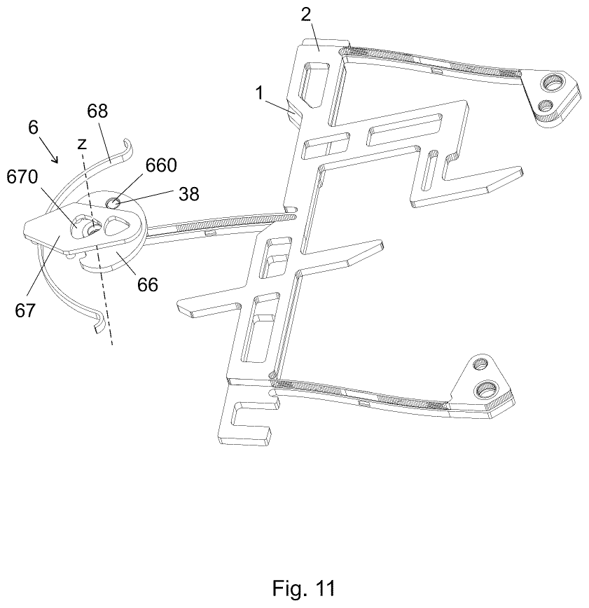

The first pivoting piece 3 in this embodiment is arranged to pivot under the action of an actuating device 6 (visible in FIG. 11) around the z-axis. It carries a pin 38, which is arranged to cooperate both with the second pivoting piece and with a third pivoting piece 66, as will be seen.

In contrast to FIG. 1, in this embodiment the frame 7 does not directly connect the two second flexible blades 5B, but there are two frames 7B, each connected to a second flexible blade 5B.

In this case too, each frame 7B may comprise one or more (through) holes 70, to fasten it to a bridge or plate of a movement comprising the watch mechanism 1000 according to the invention, for example via screws (not of FIG. 8). However, the frame 7B can be attached to a bridge or plate with other attachment means, for example via one or more pins, e.g. pivot pins (not shown), or for example also via one or more additional flexible blades (not shown), as shown for the embodiments of FIGS. 1 and 2.

In this embodiment, the first rigid piece 1, together with the first flexible blade 5A, the second flexible blades 5B and the frames 7B, forms a monobloc piece.

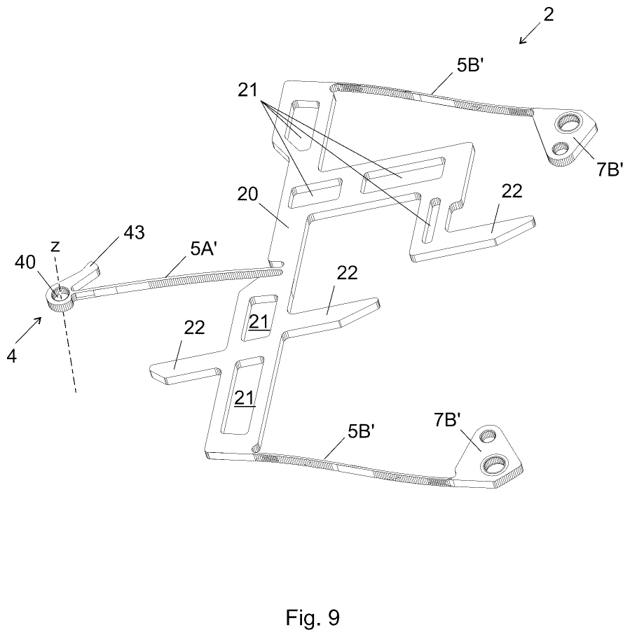

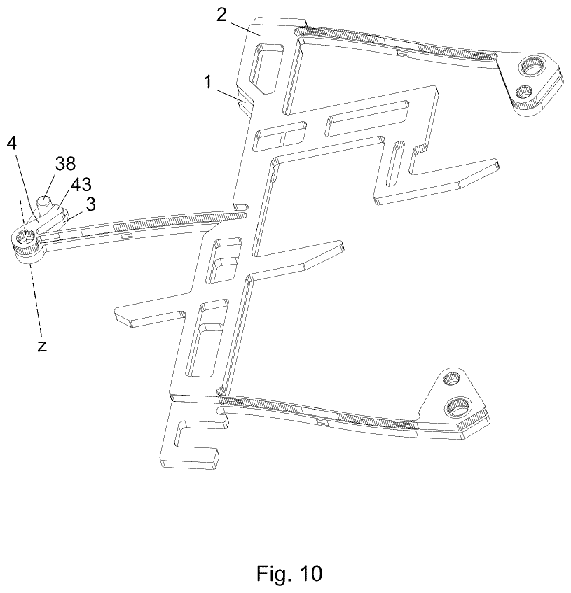

FIG. 9 shows a perspective view of the second bistable of the watch mechanism according to another embodiment of the invention, which is intended to cooperate with the first bistable, as seen in FIG. 10.

In this embodiment, the body 20 of the second rigid piece 2 has a polygonal shape. It comprises several through openings 21 of different shapes (e.g. triangular, trapezoidal, etc.), to reduce its inertia and/or to be able to activate a function.

In this embodiment, the second rigid piece 2 comprises a plurality of hammer portions 22, which are substantially perpendicular to the body 20 and project to one side and the other from the body 20. Each hammer portion 22 is arranged to cooperate with a heart piece (not shown), during the reset.

In one embodiment, the second rigid piece 2 comprises a single hammer portion 22.

In one embodiment, the second rigid piece 2 comprises several hammer portions 22, all projecting from one side of the body 20.

The considerations made above for the first flexible blade 5A and the second flexible blade 5B of FIG. 8 apply mutatis mutandis to the first flexible blade 5A′ respectively to the second flexible blade 5B′ of FIG. 9.

The considerations made above for the first frames 7B apply mutatis mutandis to the second frames 7B′.

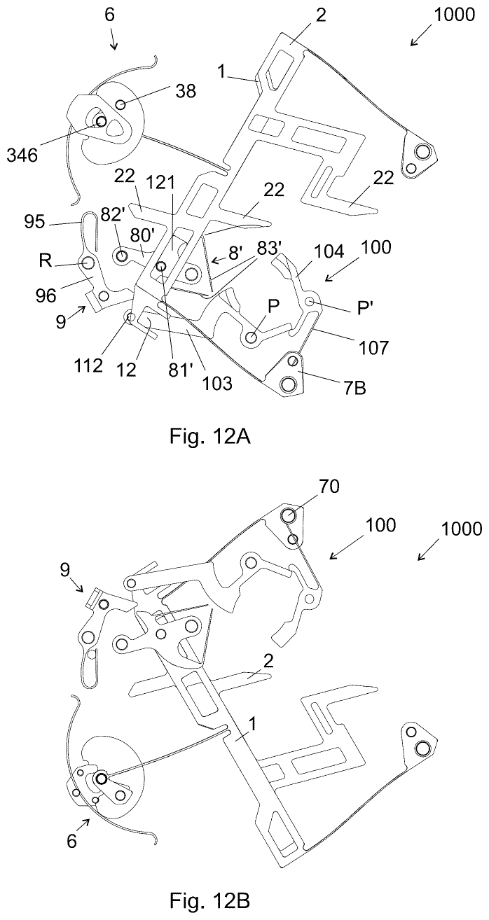

The second pivoting piece 4 in this embodiment is arranged to pivot under the action of a second actuating device 9 (not of FIG. 11, but visible, for example, in FIG. 12A) around the same axis z of the first pivoting piece. It has no openings (unlike the second pivoting piece 4 in FIG. 2) and comprises an end 43, which is arranged to cooperate with the pin 38 of the first pivoting piece 3, as will be seen.

In this embodiment, the second rigid piece 2, together with the first flexible blade 5A′, the second flexible blades 5B′ and the frames 7B′, forms a monobloc piece.

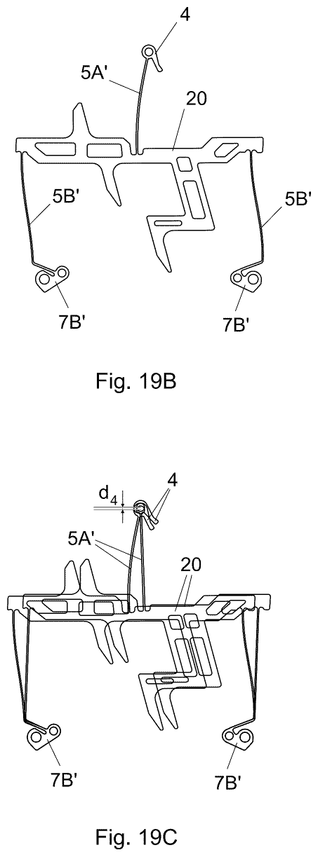

FIG. 19A shows a top view of the pivoting piece 4, the frame 7B′, the body 20 of the second rigid piece 2, the first flexible blade 5A′ and the two second flexible blades 5B′, the flexible blades 5A′ and 5B′ not being preloaded.

FIG. 19B shows a top view of the mechanism of FIG. 19A in which the flexible blades 5A′ and 5B′ are preloaded, because the pivoting piece 4 is mounted on a mechanical pivot (not shown) having a principal axis offset in the principal plane xy from the axis of rotation of the pivoting piece 4 in a non-preloaded state (that of FIG. 19A), the position of the frame 7B′ being the same in the non-preloaded (FIG. 19A) and preloaded (FIG. 19B) states. The presence of the (rigid) mechanical pivot offset from the axis of the pivoting piece 4 in its non-preloaded or initial state makes the assembly of the first rigid piece 1 and the flexible blades 5A′, 5B′ bistable. In other words, the same assembly is not bistable when the pivoting piece 4 is not mounted on the pivot, which preloads the blades 5A′, 5B′. FIG. 19C, a superimposition of FIGS. 19A and 19B, illustrates the offset d₄ between the two axes of rotation. In one embodiment, the offset d₄ is less than one tenth of the length of the shortest flexible blade 5A′, 5B′.

FIG. 10 shows a perspective view of the first bistable in FIG. 8 and the second bistable in FIG. 9. In this embodiment, the first rigid piece 1 is at least partially superimposed on the second rigid piece 2. Although in this embodiment all the openings 11 and 21 in the bodies of the first and second rigid pieces 1, 2 respectively are at least partially superimposed, this is not essential for the operation of the watch mechanism 1000.

FIG. 11 shows a perspective view of the first bistable and second bistable assembly of FIG. 10, with a first actuating device 6 of the watch mechanism according to another embodiment of the invention.

In this embodiment, the first actuating device 6 comprises a spring 68, connected to a push-lever 67.

In this embodiment, the mechanism also comprises a third pivoting piece 66, which is superimposed on the second pivoting piece 4, the second pivoting piece 4 being sandwiched at least partially between the first pivoting piece 3 and the third pivoting piece 66.

The third pivoting piece 66 comprises a through opening 660 arranged to receive the free end of the pin 38 of the first pivoting piece 3.

A second pin 346 (of FIG. 12A) is inserted into the through-openings 30 and 40 of the first and second pivoting pieces 3, 4 respectively (which are substantially aligned as seen in FIG. 10) and one of its ends is also received in the through-opening 670 of the push-lever 67.

The second pin 346 thus connects the first, second and third pivoting pieces 3, 4, 66.

When the push-lever 67 is actuated, for example by a translatory movement, the spring 68 causes the third pivoting piece 66 to pivot around the z-axis.

FIG. 12A shows a top view of the watch mechanism 1000 according to another embodiment of the invention, in the phase prior to the start phase. In this embodiment, the watch mechanism 1000 comprises, in addition to the components illustrated in FIG. 11:
a coupling mechanism 100,
a second actuating device 9, arranged to actuate a reset of an indicator member associated with a heart (not illustrated),
an intermediate piece 8′, arranged to cooperate with the second actuating device 9, in order to move the second rigid piece 2, in particular during reset, as will be seen.

In the embodiment of FIG. 12A, the coupling mechanism 100 is a clamp, comprising a first clamp portion 103 and a second clamp portion 104, each clamp portion 103, 104 being arranged to pivot around the axis of rotation P respectively P′, to clamp or unclamp a wheel connected to an indicator member (not shown) which is to be locked respectively started.

In the embodiment of FIG. 12A, the two clamp portions 103, 104 are two separate, rigid pieces that come into direct contact at one of their ends.

The first clamp portion 103 comprises a pin 112 which is arranged to be received in the housing 12 of the first rigid piece.

The second clamp portion 104 comprises a flexible blade 107, one end of which is connected to a hole 70 in frames 7B/7B′.

FIG. 12B shows a bottom view of the watch mechanism of FIG. 12A, in the phase preceding the start phase or “off” phase.

The embodiment of FIG. 12A should not be considered as being limited to the illustrated specific coupling mechanism 100.

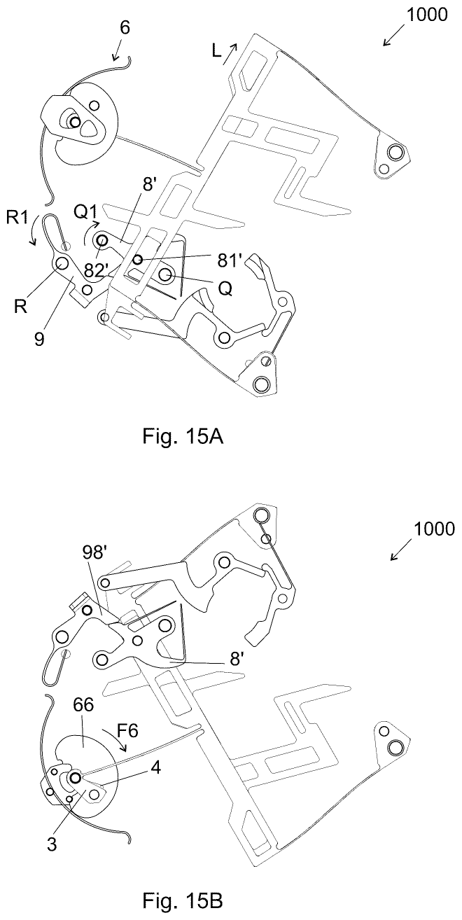

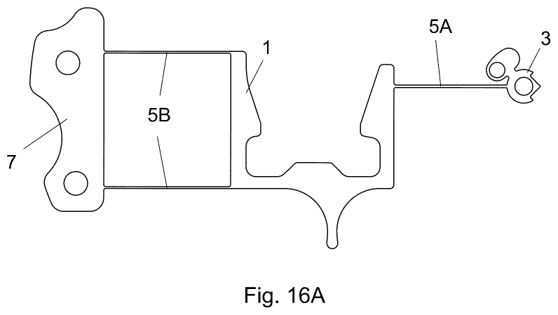

The second actuating device 9 in FIG. 12A comprises a rigid body 96 connected to a flexible blade 95, in particular a hook-shaped flexible blade. Under the action of a user, it is arranged to rotate around the axis R. It comprises a portion 98′ arranged to cooperate with the interacting piece, for example via direct contact during reset, as seen in FIGS. 15A and 15B.

The second actuating device 9 in FIG. 12A, unlike the one of FIG. 2, is not locked during the start phase. Even if it is actuated during this phase, it does not allow a reset, as its portion 98′ does not contact the intermediate piece 8′: the hammer portion(s) 22 cannot therefore actuate the heart piece(s).

In the embodiment of FIG. 12A, the intermediate piece 8′ comprises a rigid body 80′, connected to two flexible blades 83′, which can be arranged in a V-shape. This V-shape form has two functions:
returning the intermediate piece 8′ in both directions of rotation;
positioning the intermediate piece 8′ during the stop phase.

The intermediate piece 8′ also comprises a first pin 81′, arranged to be received in an aperture 121 created by the at least partial superposition of an aperture 11 of the first rigid piece with a second aperture 21 of the second rigid piece, and a second pin 82′ which is arranged to cooperate with a hammer portion 22 of the second rigid piece 2. The first pin 81′ serves in particular to disengage the reset function during the start phase.

Before actuating the actuating device 6, the first and second pivoting pieces 3, 4 are (at least partially) superimposed, as of FIG. 12B. The first and second rigid pieces 1, 2 are (at least partially) superimposed. The coupling mechanism 100 is in the disengaged position, i.e. the two clamp portions 103, 104 are at minimum spacing (clamp in closed position).

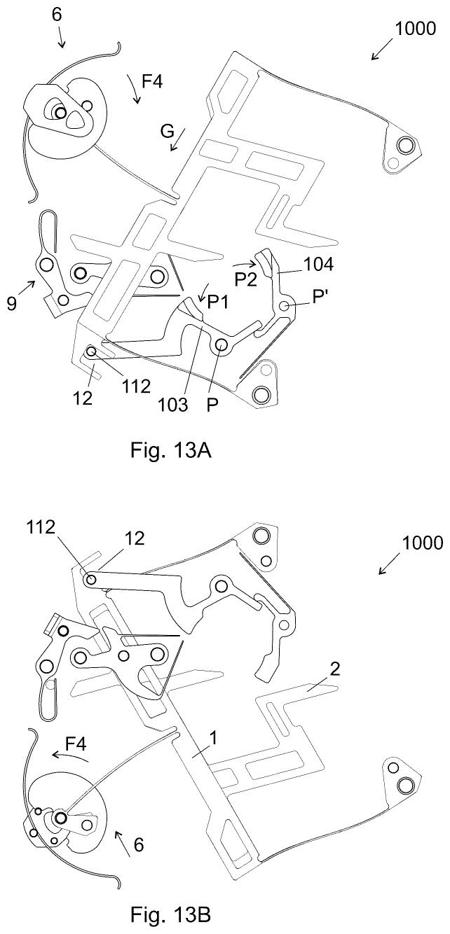

FIG. 13A shows a top view of the watch mechanism 1000 of FIG. 12A, in the start phase. FIG. 13B shows a bottom view of the watch mechanism 1000 of FIG. 13A.

When the actuating device 6 is activated, it causes the first, second and third pivoting pieces 3, 4, 66 to rotate around the z-axis in the direction indicated by arrow F4 in FIG. 13A.

The pivoting of the first pivoting piece 3 causes, thanks to the preloaded flexible blades 5A and 5B, a displacement, for example by translation along the direction of arrow G visible in FIG. 12A, of the first rigid piece 1 towards a first stable position, to achieve a coupling. In fact, the pin 112 is received in the housing 12, causing the first clamp portion 103 to rotate around the axis P in the direction of arrow P1, and the second clamp portion 104 to rotate around the axis P′ in the direction of arrow P2, opposite to that of arrow P1: the two clamp portions 103, 104 are at maximum spacing (clamp in open position), enabling the indicator member (not shown) to rotate.

The pivoting of the second pivoting piece 4 causes, thanks to the preloaded flexible blades 5A′ and 5B′, a displacement, for example by translation, always along the direction of the arrow G visible in FIG. 12A, of the second piece 2 as well.

In this start phase, the second actuating device 9 is not locked. It can therefore be actuated, but its actuation does not activate a reset, as it cannot contact the interacting piece 8′. In other words, in this embodiment, the second actuating device 9, once actuated, “operates in a vacuum” during the start phase.

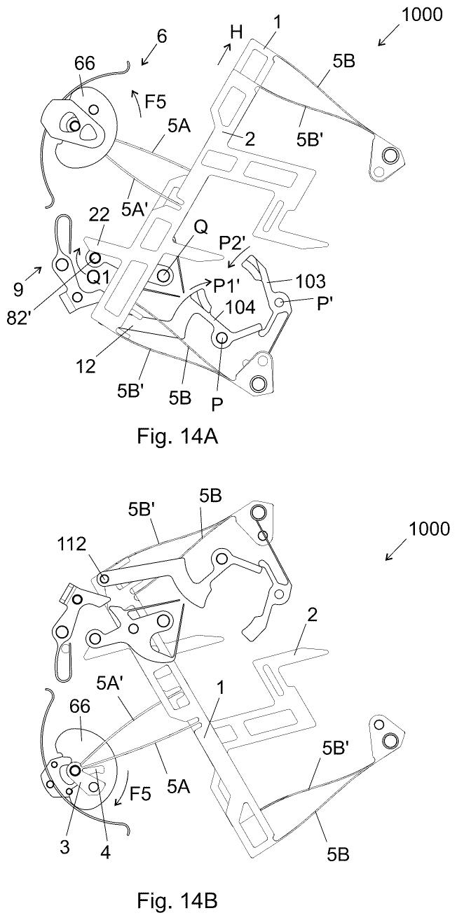

FIG. 14A shows a top view of the watch mechanism 1000 of FIG. 12A, in the stop phase. FIG. 14B shows a bottom view of the watch mechanism 1000 of FIG. 14A.

Actuating again the first actuating device 6 (or actuating another actuating device not shown) only causes the first pivoting piece 3 to pivot in a direction F5 opposite to that F4 at the start, as in FIG. 14A. The second pivoting piece 4 does not move. The third pivoting piece 66 also rotates like the first pivoting piece 3, in the same direction of rotation F5, due to the pin 38 connecting the third pivoting piece 66 to the first pivoting piece 3.

The pivoting of the first pivoting piece 3 causes, thanks to the preloaded

flexible blades 5A and 5B, a displacement, for example by translation, along the direction of arrow H visible in FIG. 14A (and opposite to the direction of arrow G in FIG. 13A), of the first piece 1 towards a second stable position, to interrupt the coupling. In fact, the displacement of the first rigid piece 1 causes the pin 112 to move out of the housing 12, as can be seen more clearly in FIG. 14: the first clamp portion 103 then rotates around the axis P in the direction of arrow P1′ (opposite to that of arrow P1 in FIG. 13A) and the second clamp portion 104 rotates around the axis P′ in the direction of arrow P2′ (opposite to that of arrow P2 in FIG. 13A). The two clamp portions 103, 104 are at minimum distance from each other (clamp in closed position), causing the (not shown) indicator to stop.

Displacement of the first rigid piece 1 also enables the interaction piece 8′ to rotate around the axis of rotation Q, in the direction of rotation of arrow Q1: the pin 82′ of the interaction piece 8′ then contacts the hammer portion 22 of the second rigid piece 2.

In this stop phase, the second piece 2 remains preloaded by means of the (second) pin 346 between the three pivoting pieces 3, 4, 66.

FIG. 15A shows a top view of the watch mechanism 1000 of FIG. 12A, in the reset phase. FIG. 15B shows a bottom view of the watch mechanism 1000 of FIG. 15A.

Actuating the second actuating device 9 now only (indirectly) causes the second pivoting piece 4 to pivot in direction F6 (visible in FIG. 15B), which is the same as F5 of the first pivoting piece 3 at stop, as of FIG. 14B. The first pivoting piece 3 does not move. Nor does the third pivoting piece 66 move.

In contrast to the embodiment of FIG. 6, in this embodiment the second actuating device 9 does not act directly on the second pivoting piece 4. Actuating the second actuating device 9 causes it to rotate around the axis R in the direction of rotation R1 of FIG. 15A, thus bringing the portion 98′ of the second actuating device 9 into contact with the corresponding portion 89′ of the interacting piece 8′.

Following this contact, the interacting piece 8′ rotates around axis Q, still in the same direction of rotation Q1 of the stop phase (FIG. 14A), which, via pin 82′, causes the second rigid piece 2 to move along the direction of arrow L visible in FIG. 15A (which corresponds to the direction of arrow H in FIG. 14A) to a second, stable position, so as to actuate the (not shown) heart piece(s) 200 via the hammer portion(s) 22.

In one embodiment, the watch mechanism 1000 according to the invention is housed in a watch case comprising a bridge or separating element defining two housings, for example one on the dial side and the other on the back side, the watch mechanism 1000 according to the invention being housed in one of these housings.

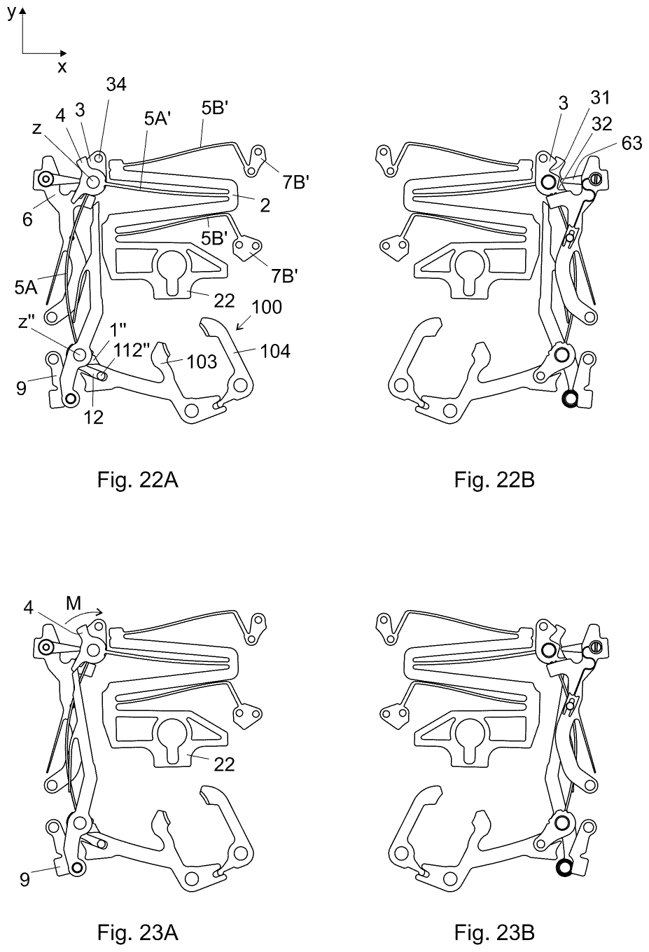

FIG. 22A shows a top view of a mechanism in another embodiment, in the phase prior to the start phase. FIG. 22B shows a bottom view of the mechanism of FIG. 22A.

In this embodiment, the watch mechanism comprises in a main plane xy:
an actuating device 6,
a pivoting piece 3, arranged to pivot under the action of the actuating device 6 around an axis z perpendicular to the main plane xy,
a rigid piece 1″,
a first flexible blade 5A connecting the rigid piece 1″ to the pivoting piece 3.

In this embodiment, the pivoting piece 3 is also a rigid piece and the rigid piece 1″ is also a pivoting piece, as it is arranged to pivot under the action of the flexible blade 5A around an axis z″ also perpendicular to the main plane xy.

Consequently, in this embodiment, the rigid pivoting piece 3 will be referred to as the rigid input pivoting piece and the rigid pivoting piece 1″ will be referred to as the rigid output pivoting piece.

In this embodiment and in accordance with the invention, the watch mechanism also comprises a mechanical pivot (not shown) in the main plane xy, with a main axis offset in the main plane xy from the axis of rotation in a non-preloaded or initial state of at least one between the rigid pivoting input piece 3 and the rigid pivoting output piece 1″.

Advantageously, the rigid pivoting input piece 3 and/or the rigid pivoting output piece 1″ are mounted on this mechanical pivot, which preloads the first flexible blade 5A and makes the assembly formed by the rigid pivoting input piece 3, the rigid pivoting output piece 1″ and the first flexible blade 5A bistable, so that the rotating rigid pivoting input piece 3 causes the bistable assembly to move in the main plane xy from a first stable position to a second stable position.

In one embodiment, this bistable is a bistable that enables the start and/or stop function of a non-illustrated chronograph-watch indicator to be executed.

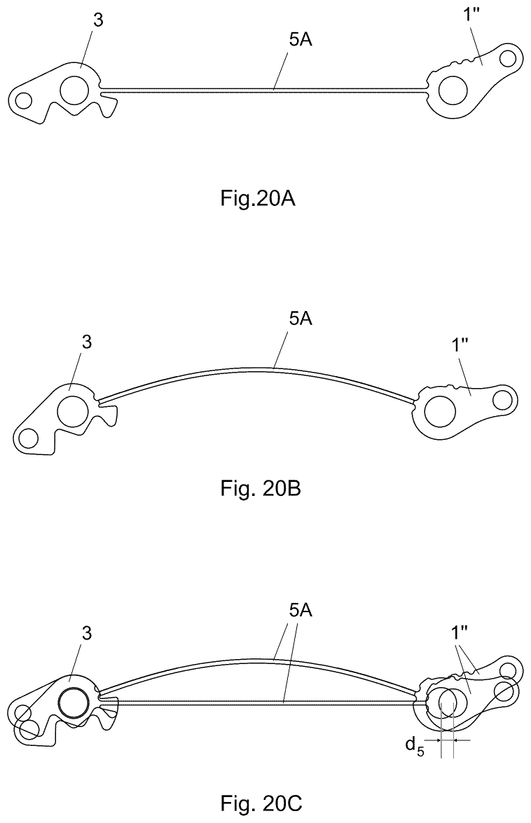

FIG. 20A shows a top view of the start and/or stop bistable, in which the flexible blade 5A is not preloaded.

FIG. 20B shows a top view of the bistable of FIG. 20A in which the flexible blade 5A is preloaded, as the rigid output pivoting piece 1″ is mounted on a mechanical pivot (not shown) having a main axis offset in the main plane from the axis of rotation of the rigid output pivoting piece 1″ in an non-preloaded state (that of

FIG. 20A), the position of the rigid pivoting input piece 3 being the same in the non-preloaded (FIG. 20A) and preloaded (FIG. 20B) states. FIG. 20C, a superimposition of FIGS. 20A and 20B, illustrates the offset ds between the two axes of rotation. In one embodiment, the offset ds is less than one tenth of the length of the flexible blade 5A″.

The embodiment of FIGS. 20A to 20C should not be regarded as restrictive, as it is also possible, for example, for the position of the rigid output pivoting piece 1″ to be the same in the non-preloaded and preloaded states, and for the rigid input pivoting piece 3 to be mounted on a mechanical pivot having a main axis offset in the main plane from the axis of rotation of the rigid input pivoting piece 3 in the non-preloaded state. It is also possible for both the rigid input pivoting piece 3 and the output pivoting piece 1″ to be mounted on a mechanical pivot having a main axis offset in the main plane from the axis of rotation of the input pivoting piece 3 respectively output pivoting piece 1″ in a non-preloaded state.

In one embodiment, the rigid pivoting input piece 3 is arranged to rotate also from a first stable position to a second stable position and when the rigid pivoting input piece 3 is in its first stable position, the bistable assembly for start and/or stop also is in its first stable position and when the rigid pivoting input piece 3 is in its second stable position, the bistable assembly for start and/or stop also is in its second stable position.

In one embodiment, when the rigid pivoting output piece 1″ is in a stable position, it is arranged to activate a coupling mechanism 100 (a clamp comprising two clamp portions 103, 104 in FIG. 20A), in order to perform a coupling, and when the rigid pivoting output piece 1″ is in another stable position, it is arranged to deactivate the coupling mechanism in order to perform a decoupling.

In one embodiment, the rigid pivoting output piece 1″ is arranged to directly activate the coupling mechanism 100 by coming into direct contact with the coupling mechanism 100. In another embodiment, the rigid pivoting output piece 1″ is arranged to indirectly activate the coupling mechanism 100.

Advantageously, pivoting of the rigid input pivoting piece 3 causes deformation of the flexible blades 5A and 5B. This deformation causes a displacement (by rotation in the case of FIG. 22A) of the rigid pivoting output piece 1″, and after this displacement a function (starting or stopping a chronograph in the case of FIG. 22A) is executed.

In one embodiment, the rigid pivoting output piece 1″ comprises a pin 112″ and the coupling mechanism 100 comprises a housing 12 arranged to receive this pin 112″, to activate the coupling mechanism 100 to perform a coupling.

In one embodiment, as seen for example in FIG. 22A, the watch mechanism comprises:
a second actuating device 9,
a second rigid piece 2, arranged to move (notably in the same plane xy of the first rigid pivoting output piece 1″) under the action of the second actuating device 9, from a first stable position (relative to a frame 7B), to a second stable position (relative to a frame 7B), the movement of the second rigid piece 2 enabling a function to be performed, for example a reset function.

In one embodiment, the second rigid piece 2 is moved by translation.

In one embodiment, and as seen for example in FIG. 22A, the watch mechanism comprises a second pivoting piece 4, arranged to pivot under the action of the first actuating device 6 (as shown for example in FIG. 20A) or another second actuating device (not shown) around an axis perpendicular to the main plane. In the embodiment of FIG. 22A, this axis is the same z-axis of the pivoting input piece 3.

In one embodiment, as shown for example in FIG. 22A, a first flexible blade 5A′ connects the second rigid piece 2 to the second pivoting piece 4, and at least one second flexible blade 5B′ (two in the embodiment of FIG. 22A) connects the second rigid piece 2 to the frame 7B.

In one embodiment, the second pivoting piece 4 is mounted on a mechanical pivot having a main axis offset in the main plane xy from the axis of rotation of the second pivoting piece 4 in a non-preloaded or initial state. This preloads the first flexible blade 5A′ and the second flexible blade(s) 5B′ and makes the second assembly formed by the second rigid piece 2, the first flexible blade 5A′ and the second flexible blade(s) 5B′ bistable so that, when the second pivoting piece 4 rotates, this bistable second assembly moves from a first stable position relative to the frame 7B′ to a second stable position relative to the frame 7B′.

In one embodiment, the second bistable assembly moves in translation. In one embodiment, the second bistable assembly moves in the main xy plane.

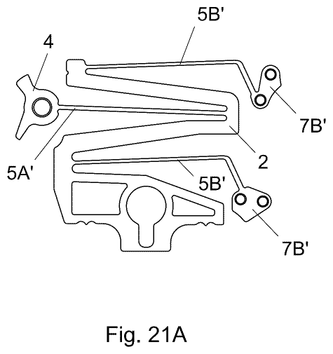

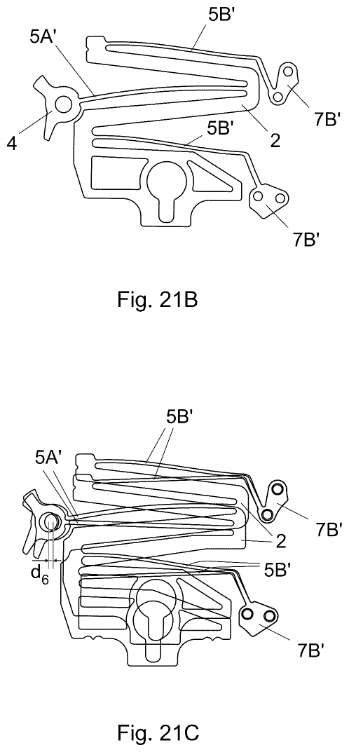

FIG. 21A shows a top view of the pivoting piece 4, the frame 7B′, the second rigid piece 2, the first flexible blade 5A′ and the two second flexible blades 5B′, with the flexible blades 5A′ and 5B′ not being preloaded.

FIG. 21B shows a top view of the mechanism of FIG. 21A in which the flexible blades 5A′ and 5B′ are preloaded, because the pivoting piece 4 is mounted on a mechanical pivot (not shown) having a principal axis offset in the principal plane xy from the axis of rotation of the pivoting piece 4 in a non-preloaded state (that of FIG. 21A), the position of the frame 7B′ being the same in the non-preloaded (FIG. 21A) and preloaded (FIG. 21B) states. The presence of the mechanical (rigid) pivot offset from the axis of the pivoting piece 4 in its non-preloaded or initial state makes it possible to render the assembly of the second rigid piece 2, the first flexible blade 5A′ and the two second flexible blades 5B bistable. In other words, the same assembly is not bistable when the pivoting piece 4 is not mounted on the pivot, thereby preloading the blades 5A′, 5B′. FIG. 21C, a superimposition of FIGS. 21A and 21B, illustrates the offset de between the two axes of rotation. In one embodiment, the offset d₆ is less than one tenth of the length of the shortest flexible blade 5A′, 5B′.

Returning to FIG. 22A, the pivoting input piece 3 and the rigid pivoting output piece 1″ are free to rotate around the pivot axes, which are the same as in FIG. 22A.

The input pivoting piece 3 may include a pin 34, which enables the hammer to be lifted on first start. The second pivoting piece 4 includes a pin 112″, which is used to actuate the coupling clamps 103, 104.

The actuating device 6 is arranged to act on the pivoting input piece 3, which in one embodiment comprises at least one notch (two in FIG. 20B, references 31 and 32). Depending on its position, a nose or a projection 63 of the actuating device 6 engages one of the notches 31, 32 and causes a pivoting of the pivoting input piece 3 and a bending of the blade 5A, until the start and/or stop bistable jumps (i.e. until the rigid pivoting output piece 1″ pivots), after which the start and/or stop bistable stops in its second stable position. The bistable can therefore be activated in both directions as many times as required.

Of course, the actuating device 6 of FIGS. 22A and 22B is non-limiting: it may be, for example, a monolithic button or another actuating device, such as one without rigid levers.

If, when the start/stop bistable is activated, the second pivoting piece 4 (which in the embodiment of FIG. 22A, is also rigid) of the reset bistable is in the “hammer against hearts” position, the start/stop pin 34 will come into contact with the second pivoting piece 4 and cause it to pivot around its axis. As a result, blades 5A′ and 5B′ of the reset bistable bend until the reset bistable jumps back into its second stable position (“lifted hammer”).

Any further actuation of the input pivoting piece 3 will only act on the start and/or stop bistable, as the pin 34 will no longer come into contact with the second pivoting piece 4 in the “lifted hammer” position.

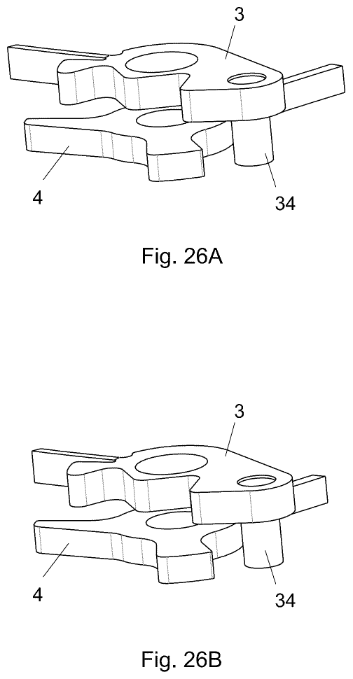

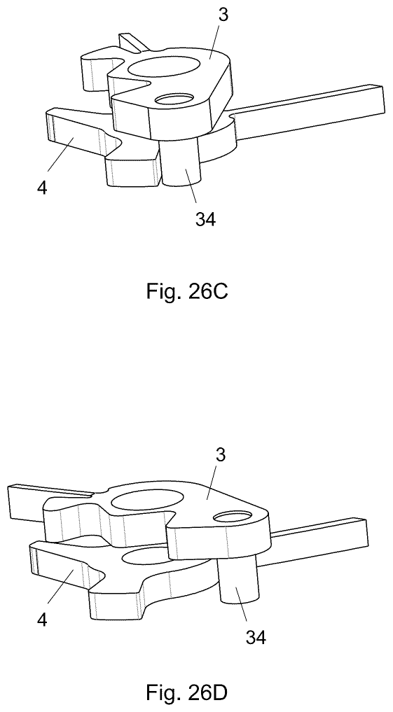

To reset the chronograph (FIGS. 23A, 23B and 26B), the previously lifted hammer 22 must be brought into a stable position resting against the (not shown) hearts. To do this, the force exerted by the user on the second actuating device 9 (e.g. via a system of mechanical levers) rotates the second pivoting piece 4 in the opposite direction (clockwise in FIG. 23A, arrow M) until the reset bistable jumps up and strikes the (not shown) chronograph hearts, bringing them to the zero position.

By pressing once more the second actuating device 9, the lever will no longer touch the pin 34 of the input pivot 3: the second actuating device 9 will therefore operate in a vacuum.

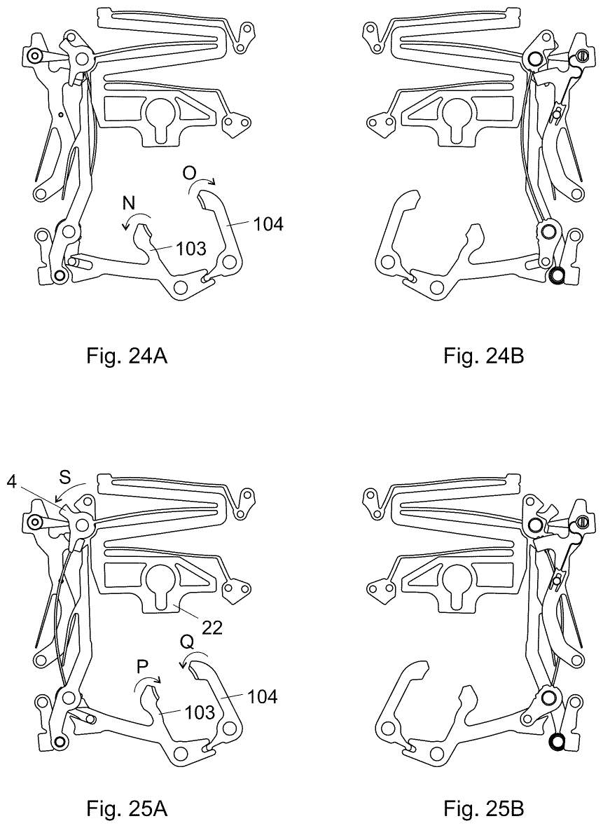

In one embodiment, when the chronograph is started (FIGS. 24A, 24B and 26C), the first actuating device 6 activates the pivoting input piece 3; the second pivoting piece 4 preloads the reset bistable via the pin 34 of pivoting input piece 3 (FIG. 26C). The rigid output pivoting piece 1″ rotates and opens the coupling clamps 103, 104 via the pin 112″. The coupling connects the chronograph to the time chain.

In one embodiment, this position of the clamps 103, 104 guarantees a stop for the second actuating device 9: the chronograph cannot be reset when it is running. In this embodiment, there is then a security for the reset.

In one embodiment, pressing the first actuating device 6 again (or another actuating device not shown) stops the chronograph (FIGS. 25A, 25B and 26D). In this case, the start and/or stop bistable assumes its second stable position. The clamps close again (arrows P and Q in FIG. 25A), and the chronograph is disengaged. In this case, the second pivoting piece 4 rotates (in the direction of arrow S in FIG. 25A) without interacting with the hammer 22, which remains preloaded. Pressing the first actuating device 6 again restarts the chronograph.

In one embodiment, when the chronograph is stopped, the indicator elements (not shown) can be reset by pressing the second actuating device 9, as there is no longer a stopper.

When the chronograph is stopped, the user can reset the indicators (not shown): pressing the second actuating device 9 causes the reset lever to pivot, this lever acting on the second pivoting piece 4 (FIG. 23A), which causes the reset bistable to jump from one stable position to the other.

During the jump, the reset bistable strikes the (not shown) hearts of the chronograph indicators, and sets them to zero.

### REFERENCE NUMBERS USED ON FIGS.

1 First rigid piece
1″ Rigid outlet pivoting piece
2 Second rigid piece
3 First pivoting piece/rigid pivoting input piece
4 Second pivoting piece
5A, 5A′ First flexible blade
5B, 5B′ Second flexible blade
6 First actuating device
7, 7′ Frame
7B, 7B′ Frame
8 Locking piece
8′ Intermediate piece
9 Second actuating device
10 Body of first rigid piece
11 Through opening of the body of the first rigid piece
12 Housing of the first rigid piece
15A First side surface of the first rigid piece
15B Second side surface of the first rigid piece
18 Projection of first rigid piece
20 Body of second rigid piece
21 Through opening of the body of the second rigid piece
22 Hammer portion
30 Through opening of the first pivoting piece
31 Notch
32 Notch
34 Pin
36 Interaction portion of the first pivoting piece
38 Pin
40 Through opening of the second pivoting piece
41 First wall of through opening
42 Second wall of through opening
43 End of second pivoting piece
46 Interaction portion of the second pivoting piece
49 Reset portion of the second pivoting piece
50A First end of first flexible blade
51A Second end of first flexible blade
50B First end of second flexible blade
51B Second end of second flexible blade
55A Opening of the first flexible blade
55B Opening of the second flexible blade
60 Rigid main body of the first actuating device
61, 62 Flexible blades of the first actuating device
63 Projection of the first actuating device
64, 65 End of first actuating device
66 Third pivoting piece (lever)
67 Push-lever
68 Spring
70 Frame hole
80 Stopper
80 Rigid body of the interaction piece
81 First rigid portion of the locking piece
81′ First pin of the interaction piece
82 Second rigid portion of the locking piece
82′ Second pin of the interaction piece
83 Flexible blade for locking device
83 Flexible blade for interacting piece
89′ Portion of interaction piece
91 First rigid portion of the second actuating device
92 Second rigid portion of the second actuating device
93 Flexible blade of the second actuating device
94 Interaction portion of second actuating device
95 Flexible blade
96 Body of the second actuating device
98 Housing of the second actuating device
98′ Portion of the second actuating device
100 Coupling mechanism
101 Wheel
102 Flange
103 First clamp portion
104 Second clamp portion
107 Flexible blade
112 Pin
112′ Pin
121 Opening
200 Heart piece
341 First end of the pin
346 Second pin
352 Second end of the pin
660 Opening the third pivoting piece
670 Opening of the push-lever
1000 Watch mechanism
A Arrow
B Arrow
C Arrow
D Arrow
d_{1 to 6} Offset
E Arrow
F1 Arrow
F2 Arrow
F3 Arrow
F4 Arrow
F5 Arrow
G Arrow
H Arrow
L Arrow
M Arrow
N Arrow
O Arrow
P Arrow
P1, P1′ Arrow
P2, P2′ Arrow
Q Arrow
Q1 Arrow
P, P′ Rotation axis
Q Rotation axis
R Rotation axis
S Arrow
xy First plan
x′y′ Second plan
z, z″ Axis
α Angle
β Angle

1. Watch mechanism comprising in a main plane:
an actuating device,
a pivoting piece, arranged to pivot under the action of the actuating device around an axis perpendicular to the main plane,
a rigid piece,
a first flexible blade connecting the rigid piece to the pivoting piece,
a mechanical pivot having a main axis offset in the main plane with respect to the axis of rotation of at least one of the pivoting piece and the rigid piece,
the pivoting piece and the rigid piece respectively being mounted on said mechanical pivot, which preloads the first flexible blade and makes the assembly formed by the rigid piece and the first flexible blade bistable, so that the rotating pivoting piece causes the bistable assembly to move in the main plane, from a first stable position, to a second stable position.

2. Watch mechanism-according to claim 1, wherein the pivoting piece is arranged to rotate also from a first stable position, to a second stable position, wherein when the pivoting piece-is in its first stable position, the bistable assembly is also in its first stable position, and when the pivoting piece is in its second stable position, the bistable assembly is also in its second stable position.

3. Watch mechanism-according to claim 1, comprising two second preloaded flexible blades, the rigid piece being arranged to move in the main plane with a translational movement.

4. Watch mechanism-according to ene of claim 1, the first and/or second flexible blade(s) comprising openings to reduce their flexural rigidity, lighten their weight and/or control their deformation.

5. Watch mechanism-according to ene of claim 1, the rigid piece comprising openings to reduce its inertia and/or to activate a function.

6. Watch mechanism-according to ene of claim 1, at least two pieces selected from the following form a monobloc piece: the rigid piece, the first flexible blade, the second flexible blade and the frame.

7. Watch mechanism-according to ene of claim 1, comprising means for fastening the rigid piece-to the frame, said fastening means comprising pins, screws and/or an additional flexible blade.

8. Watch mechanism-according to claim 1, the rigid piece being arranged to move in the main plane with a rotational movement.

9. Watch mechanism according to claim 1, comprising a coupling mechanism, wherein when the rigid piece is in a stable position, it is arranged to activate the coupling mechanism in order to perform a coupling, and when the rigid piece-is in another stable position, it is arranged to deactivate the coupling mechanism in order to perform a decoupling.

10. Watch mechanism according to claim 9, wherein the rigid piece is arranged to directly activate the coupling mechanism by coming into direct contact with said coupling mechanism.

11. Watch mechanism according to claim 9, wherein the rigid piece is arranged to indirectly activate the coupling mechanism.

12. Watch mechanism according to claim 11, wherein the coupling mechanism comprises a pin, the rigid piece comprises a housing arranged to receive said pin, to activate the coupling mechanism to perform a coupling.

13. Watch mechanism according to claim 11, wherein the rigid piece comprises a pin and the coupling mechanism-comprises a housing arranged to receive said pin, to activate the coupling mechanism to perform a coupling.

14. Watch mechanism-according to claim 1, wherein the rigid piece is a first rigid piece, wherein the actuating device is a first actuating device, the watch mechanism comprising:
a second actuating device,
a second rigid piece,
wherein the second rigid piece is arranged to move under the action of the second actuating device-from a first stable position to a second stable position, the movement of the second rigid piece enabling a function, for example a reset function, to be performed.

15. Watch mechanism according to claim 14, wherein the second rigid piece is arranged to move in a second plane different from the main plane, for example parallel to the main plane.

16. Watch mechanism according to claim 14, wherein the second rigid piece is arranged to move in the main plane.

17. Watch mechanism according to claim 14, wherein the pivoting piece is a first pivoting piece, the watch mechanism comprising:
a second pivoting piece, arranged to pivot under the action of the first actuating device or of the second actuating device-around an axisperpendicular to the main plane,
a first flexible blade, connecting the second rigid piece to the second pivoting piece,
a second flexible blade, connecting the second rigid piece to the frame, said mechanical pivot having a main axis offset in the main plane from the axis of rotation of the second pivoting piece,
the second pivoting piece being mounted on said mechanical pivot, which preloads the first flexible blade and the second flexible blade and makes the second assembly formed by the second rigid piece-bistable, the first flexible blade and the second flexible blade, so that
when the second pivoting piece-rotates, said second bistable assembly moves from a first stable position to a second stable position.

18. Watch mechanism according to ene of claim 14, comprising a heart piece, the second rigid piece comprising at least one hammer portion, to actuate the heart piece.
